(19) United States
(12) Patent Application Publication
(10) Pub. No.: US 2010/0113124 A1
(43) Pub. Date: May 6, 2010

(54) USER-SELECTED RISK-REWARD TRADEOFFS IN LOTTERIES AND OTHER WAGERING GAMES

(75) Inventors: Amir AMIRSADRI, East Greenwich, RI (US); Richard Finocchio, Everett, MA (US)

Correspondence Address: SULLIVAN & WORCESTER LLP, 1666 K Street NW, Washington, DC, 20006, US

(73) Assignee: GTECH CORPORATION, Providence, RI (US)

(21) Appl. No.: 12/261,435

(22) Filed: Oct. 30, 2008

(51) Int. Cl. A63F 13/00

(52) U.S. Cl. 463/17

(57) ABSTRACT

A method and system for facilitating the play of a multi-level game of chance. One example procedure includes receiving information indicating a player's entry in the multi-level game for a base round, the entry including at least one of a player-selected entry or a quick pick. The example procedure further includes, conditioned on the player winning the base round of the multi-level game, offering the player a choice between receiving a base prize and continued play of the multi-level game for at least an additional round.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Future draw lotteries may involve the sale of a chance in a future draw game, in which the physical ticket sold to the lottery customer includes one or more lottery numbers, either selected by the customer, selected by a system that generates the ticket, or pre-printed on the ticket. At a pre-specified future time, a number or group of numbers is randomly selected from the pool of possible numbers, e.g., by physically drawing a random number, or by computer random number generation. Tickets with numbers that match the drawn numbers are winners, and may be eligible to be redeemed for a prize.

Increasing the enjoyment and interest level of customers of in lottery tickets may cause them to purchase tickets in greater numbers and/or more frequently. In particular, the enjoyment and interest level may increase if the customers have more impact on whether the ticket is a winner or loser. Hence, rather than merely placing a wager and passively waiting to see the outcome, lottery players may desire to be more actively take part in the game. One approach to this need has been to provide probability games, such as scratch off-tickets where the area scratched affects the outcome the player achieves. However, probability game tickets have had limited commercial success, in part because of the complexity of insuring security, and also because they make it more difficult for the game operator to guarantee a desired payout from the game, as the actual payouts will depend on the players game selections.

For online drawing games, like Keno, players often sit at a venue or location while a series of sequential games occur, and the game itself may include a series of sequential drawings. Players who lose an online drawing game may lose interest, and move on the other activities, thus reducing revenue for the game operator. Secondary games that occupy players' attention after they have lost the main game may be provided, but these games do not provide the players with an active decision-making role in the game outcome.

### BRIEF DESCRIPTION OF THE DRAWINGS

FIG. 1A illustrates an example entry form for an alien invasion game, according to an example embodiment of the invention.

FIG. 1B illustrates an example electronic entry form for a soccer game, according to a second example embodiment of the invention.

FIG. 1C illustrates an example preprinted play card for a battleship game, according to a third example embodiment of the invention.

FIG. 2A illustrates an example lottery ticket for an alien invasion game, according to a first example embodiment of the present invention.

FIG. 2B illustrates an example electronic lottery ticket for a soccer game, according to a second example embodiment of the present invention.

FIG. 2C illustrates an example lottery ticket for a battleship game, according to a third example embodiment of the present invention.

FIG. 3 illustrates an alternative example game ticket, according to another example embodiment of the present invention.

FIG. 4 illustrates an example procedure for playing a game of chance, according to an example embodiment of the present invention.

FIG. 5 illustrates an example procedure for facilitating the play of a game of chance, according to an example embodiment of the present invention.

FIG. 6 illustrates an example display screen, according to an example embodiment of the present invention.

FIG. 7 illustrates a second example display screen, according to an example embodiment of the present invention.

FIG. 8 illustrates a third example display screen, according to an example embodiment of the present invention.

FIG. 9 illustrates an example game chart, according to an example embodiment of the present invention.

FIG. 10a illustrates an example ticket log for use in facilitating the play of a game of chance, according to an example embodiment of the present invention. FIG. 10b illustrates an example record in the example ticket log.

FIG. 11 illustrates an example lottery system for use in facilitating the play of a game of chance, according to an example embodiment of the present invention.

### DETAILED DECRIPTION OF EXAMPLE EMBODIMENTS

In some example embodiments of the present invention, a customer may purchase a ticket for a chance in a risk-reward game. This ticket may, in some examples, be similar to a typical Keno or online lottery game. However, in the risk-reward game, the player must win at an entry level in order to proceed to one or more higher levels where there may be an opportunity for greater rewards with increased risk. In this regard, a winning ticket at the entry level may be redeemed for an entry level prize or alternatively the player may forego the entry level prize and continue the game at a higher level with a chance for a different, typically larger prize. The amount and/or type of prize may vary depending on the level. Players who take greater risks, and advance several levels may achieve significantly larger prizes than at the base level. Thus, in a manner similar to “letting a bet ride” in a casino game, a user may have direct input, while the game is in progress, as to how much risk to take. This feature is typically not present in conventional scratch-off lottery ticket games, Keno games, or other lottery games.

In one example embodiment of the present invention, a method facilitating the play of a multi-level online numbers draw game of chance, e.g., a Keno-type game, may be provided. The example method may include receiving information indicating a player's entry in the multi-level game for a base round, the entry including at least one of a player-selected set of entry numbers or a quick pick set of entry numbers. The example method may also include providing a receipt to the player including a representation of the player's entry numbers for the base round of the multi-level game. The example method may also include, after entering the player in the base round of the multi-level game, randomly determining a set of winning draw numbers for the base round of the multi-level game. The example method may also include determining whether the player entry is a winning entry in the base round of the multi-level game based, at least in part, on a comparison of the player entry numbers and the winning draw numbers for the base round; conditioned on the player winning the base round of the multi-level game, offering the player a choice between receiving a base prize and continued play of the multi-level game for an additional round. The example method may also include, responsive to the receipt of information indicating the player's choice to receive the base prize, awarding the base prize to the player and ending the player's participation in that instance of the multi-level game. The example method may also include, responsive to the receipt of information indicating the player's choice to continue play of the multi-level game for the additional round, entering the player in the additional round of the multi-level game. The example method may also include, after entering the player in the additional round of the multi-level game, randomly determining an additional set of winning draw numbers for the additional round of the multi-level game; determining whether the player entry is a winning entry in the additional round of the multilevel game based on a comparison of the player entry numbers and the additional set of winning draw numbers. The example method may also include, conditioned on the player winning the additional round of the multi-level game, awarding the player a larger prize of greater value than the base prize.

In some cases, the first example method may also include, conditioned on the player losing the additional round of the multi-level game, at least one of awarding the player no prize for that instance of the multi-level Keno game or awarding the player a consolation prize that is less in value than the base prize in the multi-level game.

In some cases, the first example method may also include, responsive to the player winning the additional round of the multi-level game, offering the player a choice between receiving the additional prize and continued play of the multi-level game for a second additional round; responsive to the receipt of information indicating the player's choice to receive the additional prize, awarding the additional prize to the player and ending the player's participation in that instance of the multi-level game; responsive to the receipt information indicating the player's choice to continue play of the multi-level game for the second additional round, entering the player in the second additional round of the multi-level game; after entering the player in the second additional round, randomly determining a second additional set of winning draw numbers for the second additional round of the multi-level game; determining whether the player entry is a winning entry in the second additional round of the multilevel game; based on a comparison of the player entry numbers and the second additional set of winning draw numbers; and conditioned on the player winning the second additional round of the multi-level game, awarding the player a second larger prize that is greater in value than the largest prize in the previous round. Optionally, the method may also include, conditioned on the player losing the second additional round of the multi-level game, at least one of awarding the player no prize for that instance of the multi-level game or awarding the player a consolation prize that is less in value than the larger prize in the multi-level game.

In some cases, the first example method may also include, providing a set of preprinted game cards, each including a respective set of entry numbers; and receiving information indicating a player selection of one of the set of preprinted game cards, wherein the information indicating a player's entry is determined based on the information indicating a player selection one of the set of preprinted game cards and the player's entry includes the respective set of entry numbers from the player's selected game card.

Optionally, in any of the above instances of the first example method, the receipt may be at least one of a printed ticket or an electronic ticket. The method may also include receiving information indicating additional entry numbers for the player for the additional round of the multi-level game, wherein the result of the additional round is based at least in part on a comparison of the player's additional entry numbers and the additional draw numbers. The method may also include displaying the draw numbers to the player on a video display, for example, using at least one of a sports theme, a racing game theme, a casino game theme, or a board game theme.

Optionally, in any of the above instances of the first example method, the player's choice to continue play of the multi-level game rather than receive the base prize may be indicated by the failure of the player to redeem a winning ticket for the initial game round before a predetermined deadline, rather than by a direct input or request.

In a second example embodiment according the present invention, an example method for facilitating the play of a multi-level game of chance may be provided. The example method may include receiving information indicating a player's entry a base round in the multi-level game of chance. The method may also include providing a receipt to the player, the receipt including a representation of the player's entry for the base round of the multi-level game. The method may also include randomly determining a set of winning entries for the base round of the multi-level game. The method may also include determining whether the player's entry is a winning entry in the base round of the multi-level game based, at least in part, on a comparison of the player's entry and the winning entries for the base round. The method may also include, conditioned on the player winning the base round of the multi-level game, offering the player a choice between receiving a base prize and continued play of the multi-level game. The method may also include, responsive to the receipt of information indicating the player's choice to receive the base prize, awarding the base prize to the player and ending the player's participation in that instance of the multi-level game. The method may also include, responsive to the receipt of information indicating the player's choice to continue play of the multi-level game, entering the player in an additional round of the multi-level game. The method may also include randomly determining an additional set of winning entries for the additional round of the multi-level game. The method may also include determining whether the player entry is a winning entry in the additional round of the multilevel game based, at least in part, on a comparison of the player entry and the additional set of winning entries. The method may also include conditioned on the player winning the additional round of the multi-level game, awarding the player a larger prize than the base prize.

In some alternatives, the example method may also include, conditioned on the player losing the additional round of the multi-level game; at least one of awarding the play no prize for that instance of the multi-level game or awarding the player a prize smaller than the base prize. In some other alternative examples, the player entry in the additional round may be the same as the player entry in the base round. The method may also include receiving an additional entry from the player, the additional entry being different than the base entry, the result of the additional round depending at least in part on a comparison between the additional entry and the additional set of winning entries. Optionally, the player entry selection for the additional round may be made after the player receives an indication that the initial entry is a winner. Optionally, the player entry is a player-selected set of number-symbol pairs, and the winning entry is a randomly drawn set of number-symbol pairs.

In some alternatives, the example method may also include displaying the winning entries to the player on a video display. The display may optionally include at least one of a sport game theme, a racing game theme, a board game theme, or a casino game theme.

Optionally, the example method may also include providing a set of preprinted game cards, each game card including a respective set of entry information; receiving information indicating a player selection of one of the set of preprinted game cards, wherein the information indicating a player's entry is determined based on the information indicating a player selection one of the set of preprinted game cards, and the player's entry is based on the entry information on the player-selected game card.

In addition to the features described above, the example method may optionally include reading the player entry from player-completed entry form. Optionally, the receipt may include an authentication code, and the method may include receiving the authentication code from the receipt as part of a player's claim for a prize; and authenticating the receipt using the authentication code prior to paying the prize to the player. Optionally, the method may also include receiving a lottery entry form from the player, the lottery entry form including a representation indicative of a multi-level game; and an area having a player-indicated selected set of numbers for a player entry associated with at least one round of the multi-level game.

In some alternatives, the player's choice to continue play of the multi-level game is indicated by the failure of the player to redeem a winning ticket for the initial game round by a predetermined deadline.

A third example method for facilitating the play of a multi-level game of chance may also be provided. The method may include receiving information indicating a player's entry a base round in the multi-level game of chance. The example method may also include providing a receipt to the player, the receipt including a representation of the player's entry for the base round of the multi-level game. The example method may also include randomly determining a set of winning entries for the base round of the multi-level game. The example method may also include determining whether the player's entry is a winning entry in the base round of the multi-level game based, at least in part, on a comparison of the player's entry and the winning entries. The example method may also include, conditioned on the player's presenting their ticket for redemption of a base round prize and on the player's entry being a winning entry in the base round, awarding the base prize to the player and ending the player's participation in that instance of the multi-level game. The example method may also include, conditioned on the player winning the base round of the multi-level game, and the player failing to redeem their ticket prior to a predetermined deadline, automatically entering the player in an additional round of the multi-level game; randomly determining an additional set of winning entries for the additional round of the multi-level game. The example method may also include determining whether the player entry is a winning entry in the additional round of the multilevel game based on a comparison of the player entry and the additional set of winning entries. The example method may also include, conditioned on the player winning the additional round of the multi-level game, awarding the player a larger prize than the base prize.

In another example embodiment of the present invention an article of manufacture may be provided. The article of manufacture may include a computer-readable medium having stored thereon instructions adapted to be executed by a processor, the instructions which, when executed, define a series of steps to be used to control a method. The method may be any of the example methods described previously, or elsewhere in the present application.

In another example embodiment of the present invention, a system facilitating the play of a multi-level game of chance may be provided. The example method may include an input device configured to receive information indicating a player's entry in the multi-level game for a base round, the entry including at least one of a player-selected set of entry information or a quick pick entry. The example method may also include an output device configured to provide a receipt including a representation of the player's entry for the base round of the multi-level game. The example method may also include a random outcome generator configured to determine a winning draw for the base round of the multi-level game. The example method may also include a processor in communication with the input device, the output device, and the random outcome generator. The processor may be configured to determine whether the player entry is a winning entry in the base round of the multi-level game based, at least in part, on a comparison of the player entry for the base round and the winning draw for the base round. The processor may also be configured to, conditioned on the player having a winning entry in the base round and responsive to the receipt of information indicating the player's choice to receive the base prize from the input device, to cause the base prize to be awarded the player and to end the player's participation in that instance of the multi-level game. The processor may also be configured to, responsive to the receipt of information indicating the player's choice to continue play of the multi-level game for the additional round, to enter the player in the additional round of the multi-level game. The processor may also be configured to, after the player is entered in the additional round of the multi-level game, to receive an additional winning draw for the additional round of the multi-level game from the random outcome generator and to determine whether the player entry is a winning entry in the additional round of the multilevel game based on a comparison of the player entry and the additional winning draw. The processor may also be configured to, conditioned on the player winning the additional round of the multi-level game, to cause a prize of greater value than the base prize to be awarded to the player.

Optionally, the processor may be further configured to, conditioned on the player winning the base round of the multi-level game, to cause an offer to be made to the player, the offer including a choice between receiving a base prize and continued play of the multi-level game for an additional round. The receipt may include one of a printed ticket, an electronic ticket, printed information added to a pre-printed player-selected play card, an email, a mobile telephone text message, or information stored on a smart card.

In one alternative, the system may also include a plurality of pre-printed entry cards including entry information, wherein the input device is further configured to receive information identifying a player-selected pre-printed entry card, and wherein the processor is further configured to determine whether the player is a winner based, at least in part, on the entry information from the player-selected pre-printed entry card.

Optionally, the system may also include an electronic display in communication with the processor, the display configured to display the winning draw to the player. The input device may be at least one of an agent-operated lottery terminal, a player-operated kiosk, a mobile telephone, a PDA, a personal computer, or an Internet web page that is accessed by the player. The player entries and winning drawings may be selected numbers from a predetermined range of numbers, or alternatively a set of symbol-number pairs selected from a predetermined population of symbol-number pairs.

According to another example embodiment of the present invention a system for facilitating the play of a multi-level game of chance may be provided. The system may include an input means for receiving information indicating a player's entry in the multi-level game for a base round, the entry including at least one of a player-selected entry or a quick pick entry. The system may also include an output means for providing a receipt to the player including a representation of the player's entry for the based round of the multi-level game. The system may also include a randomization means for determining a winning draw for the base round and an additional winning draw for an additional round of the multi-level game. The system may also include an entry evaluation means for determining whether the player entry is a winning entry in the base round of the multi-level game based, at least in part, on a comparison of the player entry and the winning draw for the base round and for determining whether the player entry is a winning entry in the additional round of the multi-level game based, at least in part, on a comparison of the player entry and the additional winning. The system may also include an offer means for causing an offer to made to the player, the offer including a choice between receiving a base prize and continued play of the multi-level game for an additional round. The system may also include a prize awarding means for, conditioned on the player winning the base round and choosing to receive the base prize, causing the base round prize to be awarded to the player, and for, conditioned on the player choosing to play the additional round and winning the additional round, causing an additional round prize larger than the base round prize to be awarded to the player. Optionally, the offer means may also be for causing an offer to be made to the player, the offer including a choice between receiving a prize for the additional round and continued play of the multi-level game for a second additional round. The prize awarding means may also be for, conditioned on the player choosing to play the second additional round and winning the second additional round, causing a second additional round prize larger than the additional round prize to be awarded to the player.

It will be appreciated that any of the above or below described method example embodiments may be provided using any of the above or below described system embodiments or on other systems not described herein. Similarly, any of the above or below described system example embodiments may be operated to provide any of the above or below described method embodiments, or other methods as well.

By way of illustration, described below are several example risk reward games that may be provided using some of the various example systems and methods mentioned above.

An exemplary risk-reward game may involve, for example, an Alien Invasion game having three levels: Level 1, Level 2 and Level 3. At Level 1, players pay a certain amount (e.g., $2) for the opportunity to win a greater amount (e.g., $5) by correctly matching three out of four aliens. The aliens may be a presentation hiding a conventional number or number-symbol selection, drawing and matching game, similar to a Keno-game or lottery drawing game. Here, at this level, the exemplary risk-reward game may be configured so that one in every four players will win and have the opportunity to “cash out” or continue playing at the next level, i.e., Level 2, at a risk of losing at least some of his Level 1 winnings. It will be appreciated that winning odds can vary beyond the one in four example described here, e.g., with a greater or lower expected return, or even a return that varies depending on the number of players who enter the game or who choose to play the bonus round.

At Level 2, the level of difficulty is increased, as players must now correctly match four out of nine numbers in order to have the opportunity to advance to the next level. However, by forgoing the entry level prize (in whole or in part) and continuing on, players have an opportunity for a different (e.g., larger) prize, or other form of increased winnings to reward the additional risk they have taken (e.g., $200). Even if a player does not win at this level, a guaranteed consolation prize may be provided (e.g., $3). In this regard, the guaranteed consolation prize may further entice players to continue to the next level since taking a chance at the increased winnings (e.g., $200) may only involve risking a comparably small amount (e.g., $2). The drawing or result for the additional round may be provided using a special additional round drawing, or by linking several conventional game drawings together, using another instance of the conventional game as the additional draw for the multi-level game. So, for example, the drawings could be successive Keno draws held at regular intervals, or conventional lottery drawings held on successive days or weeks.

At Level 3, players have the option to cash out at the increased winnings (e.g., $200) or continue playing the game for a chance to win an even greater amount (e.g., $25,000). As in Level 2, players who do not win the top prize here may be provided with a consolation prize (e.g., $25).

The exemplary risk reward game may include animation to enhance the look and feel of the game. In this regard, the exemplary risk reward game may involve a variety of popular themes, including, for example, video games, casino games, sports or sports games simulations, board games, television series, racing or simulated racing, licensed properties, fantasy games, etc.

### Example Entry Form

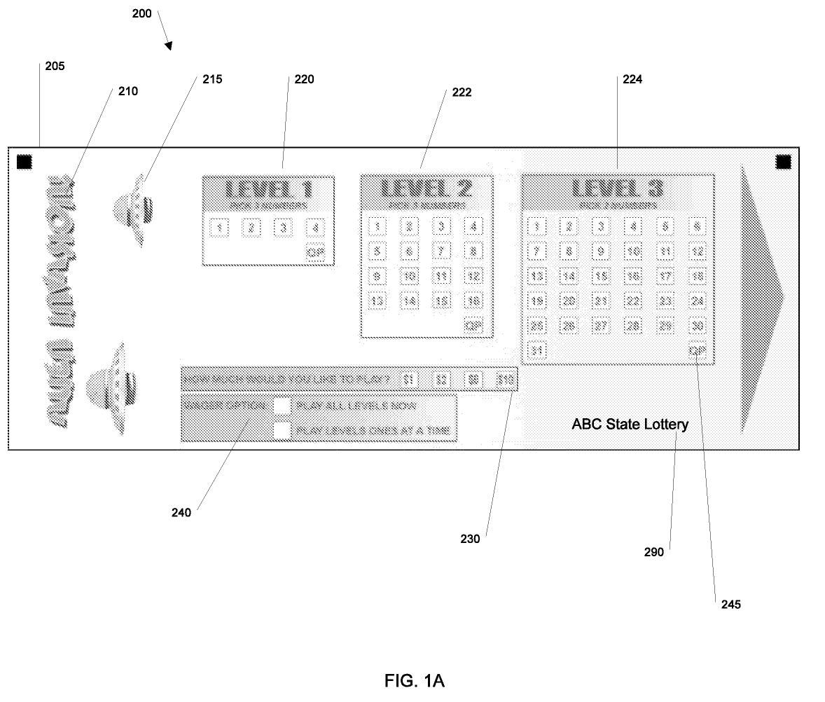

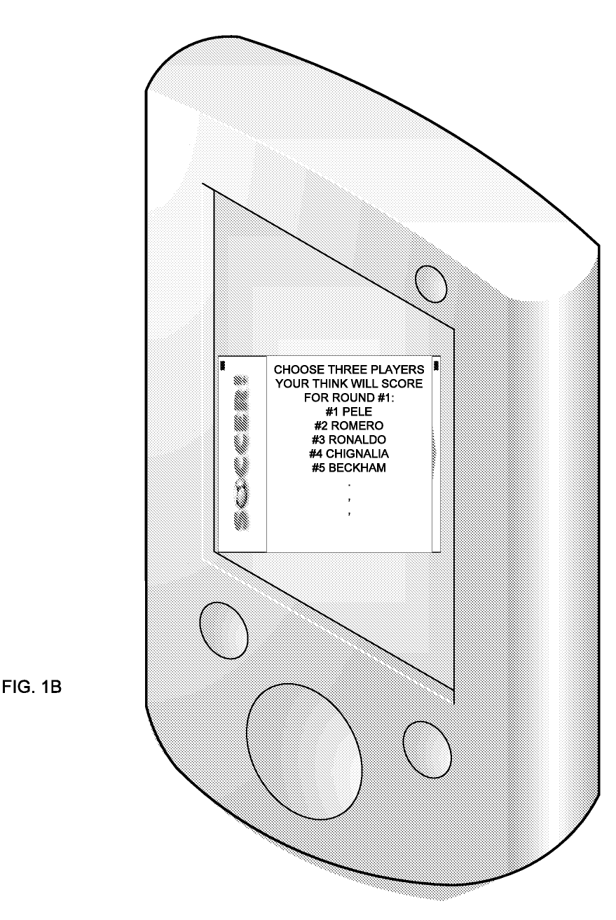

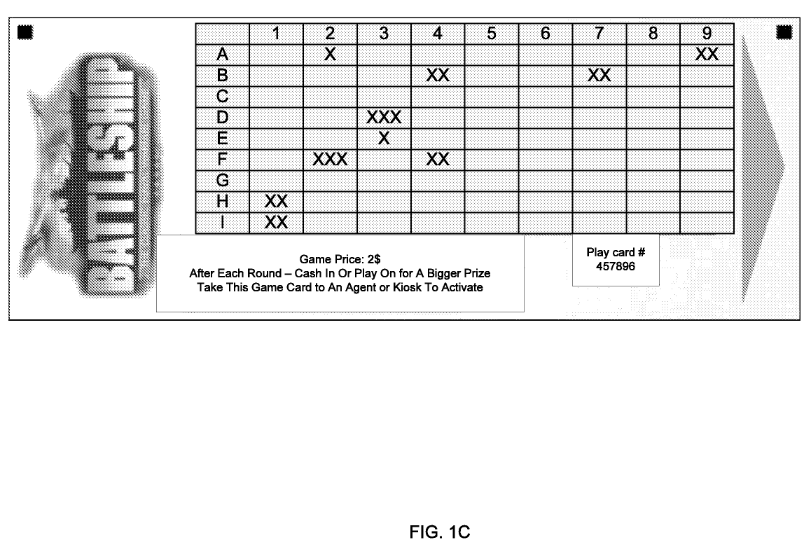

FIG. 1A illustrates an example entry form 200 for facilitating the playing of a game of chance, according to an example embodiment of the present invention. The example entry form is illustrated here as a play slip 200, that may be completed by a player and used to acquire a ticket for the play of a game of chance. The example entry form 200 may be offered, for example, at establishments offering a game of chance and distributed to customers who wish to play. The example entry form 200 may be for a risk-reward type game, such as the illustrated Alien Invasion. The example entry form 200 may be provided on a substrate, e.g., a printable substrate 205, such as paper, card stock, plastic, or various laminates, and may be either preprinted or printed to order. For example, the preprinted play slip could be distributed with other merchandise, lottery tickets, or in periodicals. Additionally, it will be appreciated that example entry form 200 alternatively may be electronic or depicted on a display (although this is illustrated in more detail in a later-described example embodiment). For example, entry form may be provided in digital form on a smart card or other electronically readable media, or an electronic form provided, e.g., over the Internet on a personal computer, mobile phone, or other device. A customer may use an example entry form 200 to acquire a ticket. A customer may make indications on the form to indicate the customer's preferences, for example, by writing or by making selections on an electronic form. Information may be found on both sides of the example printed entry form 200. The example entry form 200 and indications marked on the form may be machine readable such that a machine may generate a ticket for the game, based on information read from the example entry form 200.

The example entry form 200 may include a game type indication 210 to indicate the type or name of game for which the entry form 200 may be used to play. For example, in FIG. 1A, the example entry form 200 indicates that it may be used to play an Alien Invasion game. In this regard, the example entry form 200 may include further indications representing various, e.g., thematic aspects of the game, including, for example, indications to represent alien spaceships 215. It will be appreciated that the example entry form 200 may be configured in a variety of ways so that the example entry form 200 may be used for other games as well, including, for example, a sports game or a board game using a common entry form, e.g., by including an option to select which type of game is to be entered.

The example entry form 200 may include areas 220 to indicate a customer preference with respect to a selected set of numbers for a particular play level. In this instance, areas 220, 222 and 224 are provided for three play levels, i.e., Level 1, Level 2, and Level 3, respectively, in which the customer is directed to pick three numbers for Level 1, five numbers for Level 2, and two numbers for Level 3. In this regard, the customer may place an indication mark using, for example, a marking pencil or pen. The indication mark may be made, for example, by underlining, circling, marking an “X”, placing a dot and/or highlighting, etc. It will be appreciated, that while in this example embodiment, the customer provides entries for three rounds of the game, alternatively, the customer could provide entries prior to playing in each round of the game, or could use the same entries in multiple rounds.

The example entry form 200 may include a quick pick field 245 to indicate a desire by the customer that the numbers be automatically generated rather than determined by the customer.

The example entry form 200 may include a wager amount field 230 to indicate the amount of money that the customer would like to risk on a chance in that game. For example, in FIG. 1A, a player may risk $1, $2, $5, or $10. It will be appreciated that the amounts listed in the wager amount field 230 may vary.

The example entry form 200 may include a wager option field 240 to indicate a preference to wager on all levels at once or one level at a time. In the all levels at once option, the player is automatically entered in a three round game—the risk-reward choice element is not activated. In the “one level at a time option”, the player will choose, after each round completed, whether to enter an additional round, e.g., by activating the ticket. Alternatively, the player may be automatically entered in each round by default, and only the redemption of a winning ticket prior to the play of a round, prevents the player from being entered in the next round.

The example entry form 200 may also include a quantity of games field (not shown) to select the number of games that the customer would like to play. So the player could enter multiple instances of the same game, with the same entry numbers, in a manner similar to a conventional Keno game. Each instance would, if the player chose the one level at a time option, have the multiple round risk-reward elements described herein.

The example entry form 200 may also include information not directly involved in the play of a game. Located on the example entry form 200 may be instructions for playing the game or for the use of the example entry form 200. Additionally, the instructions may include a chart indicating the prize received for a winning combination of numbers at each level, e.g., on the back of a printed play slip or entry form. This information, optionally, may be disposed on the side of the ticket which illustrates the game indicia or may be disposed on the side opposite the game indicia.

It will be appreciated that other information 290 may be included in the example entry form 200, e.g., the identity of the agent providing the entry form, an identification number for the point of sale terminal that the entry form was received from, additional advertising information, coupons, etc. Optionally, tickets might be uniquely associated with a player, e.g., by including a player id number or name, in order to prevent the loss or theft of tickets, or to allow the use of prepaid electronic funds accounts. Rules of the game and/or legal disclaimers may be printed on the entry, e.g., on the reverse side. Additional security and authentication information may also be added, e.g., multiple layers, special marks, etc.

### Example Electronic Entry Form

FIG. 1B illustrates an example electronic entry form for facilitating the playing of a game of chance, according to a second example embodiment of the present invention. The example entry form may be used to acquire a ticket for the play of a game of chance using an electronic device with a video display, e.g., a personal computer, kiosk, terminal, PDA, or mobile phone. Here, the form is illustrated on a PDA. Depending on the particular rules of the game, information similar to that provided with the paper entry form may be provided to and received from the player. The various information may collected through a series of questions or screens, where the player enters or selects appropriate answers. The information may then be transmitted for processing, either as a sequence of communications, or as single transaction, e.g., driven by a JAVA interface on the PDA device that gathers the information and then forwards it for acceptance to a game server using an email or SMS text message.

Here, a soccer type game is illustrated. The player chooses from a set of soccer players, predicting which player(s) will make a penalty kick, e.g., three of ten players. All the players may be equally likely to complete the kick successfully. This would make the game similar to choosing three numbers from a random number drawing, or different odds may be provided for different players giving different chances of success and different prizes. In another alternative, the results could be provided by a random determination for each player, rather than by drawing a certain number of players from the group who will be successful. As a presentation for the results of the game's random drawing game, the game results can then be displayed as an animated video of the penalty kicks, the results of which are in fact determined by a random drawing, with appropriate video shown to reflect the results. This game would be particularly suited in a bar or other social setting, where players with an interest in soccer could watch the action together.

In contrast with the first example embodiment described previously, in this second example embodiment, the player only is making entries for a single round on the electronic input form. If, after winning the first round, the player chooses to play additional rounds (either by default, or by making an appropriate positive indication), the same player entries may be used in the succeeding round. So, for example, the same list of players would take penalty shots again, with a new random result. This approach is particularly well-suited to allowing players to play multiple rounds in conjunction with other players who are playing either single rounds or different numbers of multiple rounds, as the same results drawing and display can be used for all the players regardless of what round of their own game they are playing.

### Preprinted Example Entry Form

In a third example embodiment, a pre-printed ticket may be used by the player to enter the game. The use of pre-printed tickets for games allows visually attractive eye-catching graphics to be used, similar to those used in instant lottery scratch-off tickets, or in the games such as are described in U.S. Published Patent Application 2006/0258433, entitled “Hybrid Online Instant Lottery.” For example, a display of a variety of preprinted tickets, all of which are attractive and colorful may be provided. Each play card may include a respective set of entry information in a form visible to the player, as well as an identifier that indicates to the system the identity of the play card. The player may choose a desired play card from a display of pre-printed tickets and pay to activate the selected play card or to receive a corresponding game ticket. Alternatively, the preprinted play cards may be sold for a particular drawing, in a manner similar to an instant win scratch-off lottery ticket.

FIG. 1C illustrates an example pre-printed play card, according to the third example embodiment of the present invention. This example is for a Battleship-type game. The pre-printed play card shows a set of guesses or selections of number-symbol pairs, e.g., grid coordinates. These guesses or selections are marked on the play card in a manner to show which round of the game the selections are for, e.g., “x” for the first round, “xx” for the second round, and “xxx” for the third round. Thus, the printed card provides pre-made guesses or selections for the player in the drawing game. The drawing results could then be revealed with a dramatic animated presentation such as, for example, warships shooting at and hitting targets. The player pays a single price, indicated on the game card, here 2$, to activate the play card, or in this example to receive a corresponding receipt or ticket. To facilitate the activation, the play card may include a play card identifier in human and/or machine readable form, so that the system can determine what play card the player has and the corresponding drawing entries when the card is presented for activation.

In this example, the player is automatically entered in each additional round, if the win the preceding round. To claim the prize, and avoid risking it in the subsequent round, the player would need to cash the ticket in for the appropriate prize before the next round begins. It will be appreciated that the opposite approach could also be provided, for example, only entering a player in a second or additional round when the player makes a choice to enter such a round, e.g., when the winning ticket or receipt is presented for redemption.

### Example Ticket for Playing a Game of Chance

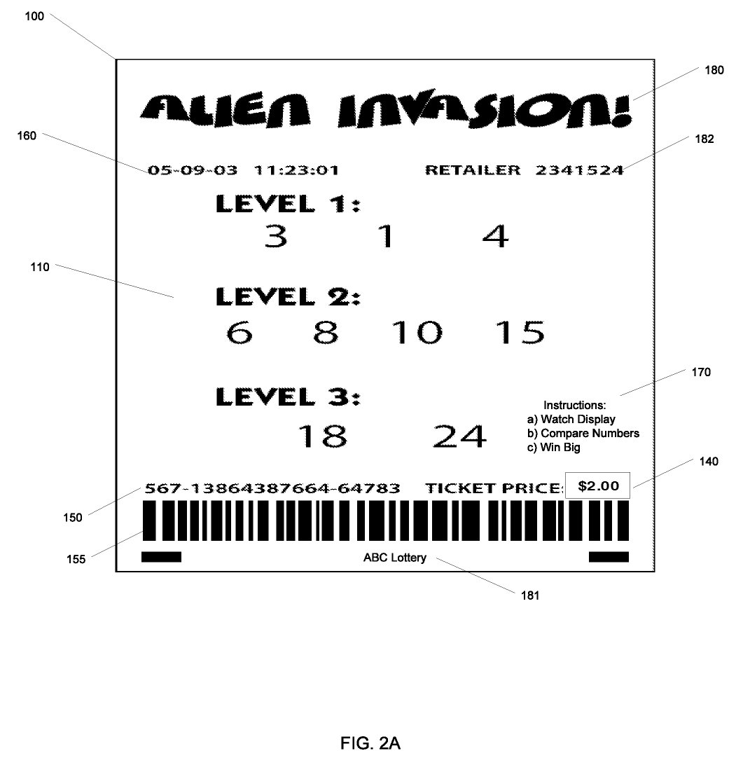

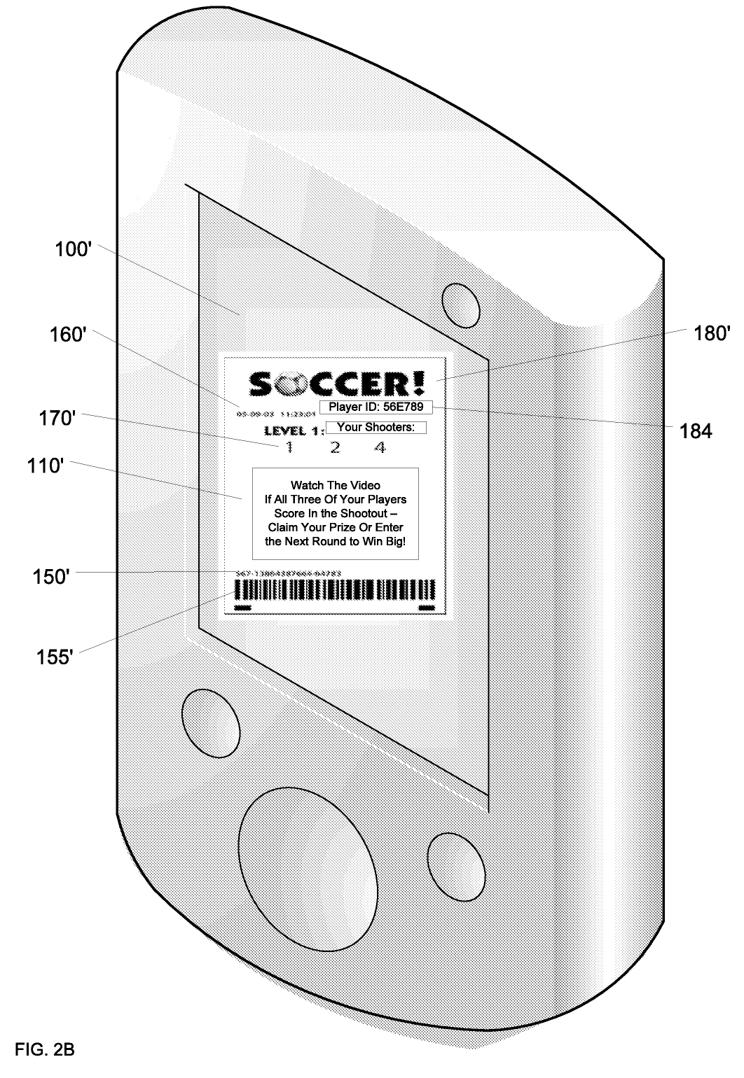

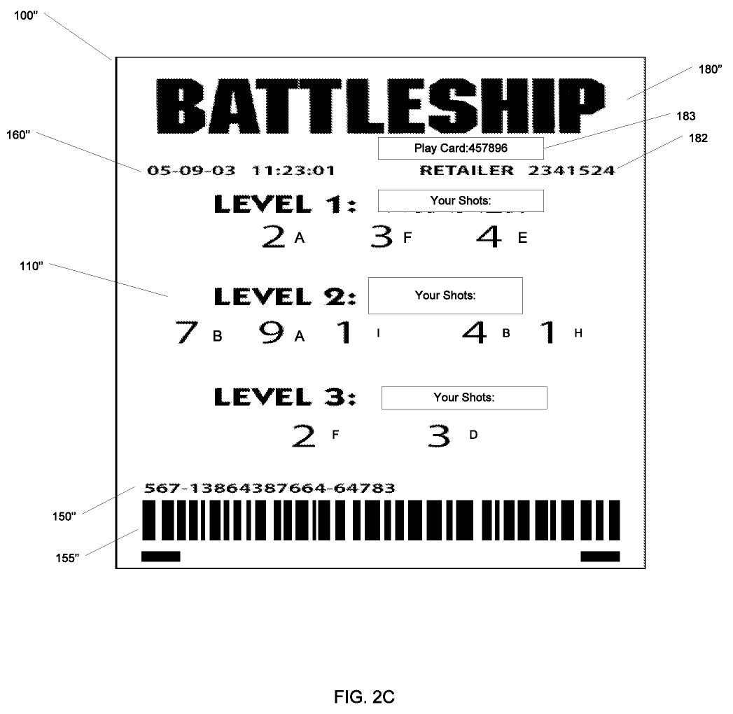

FIG. 2A illustrates an example ticket 100, according to an example embodiment of the present invention. The example ticket 100 may be for a risk-reward game, such as the Alien Invasion game for which the play slip was described in FIG. 1A. The example ticket 100 may be received in a variety of ways, e.g., by requesting a ticket from a cashier or establishment operator, by purchasing a ticket from a vending machine that generates such tickets, or by purchasing a pre-printed ticket, e.g., from a ticket display. The example ticket 100 may include a variety of information. For example, a ticket may include a game play display area 110, an authentication code 150, a time/date field 160, game instructions 170, or an amount wagered field 140. It will be appreciated that a ticket 100 may be received for a number of games of chance. Additionally, multiple chances may be purchased in a single game.

The example ticket 100 may be printed on a substrate, e.g., a printable substrate such as paper, card stock, plastic, or various laminates. Additionally, it will be appreciated that the example ticket 100 may be electronic or depicted on a display screen, e.g., a personal data assistant (PDA), mobile telephone, personal computer, or terminal used by the player. Information may be displayed on both sides of the example ticket 100, or on one or more screens, in the case of electronic display.

The example ticket 100 may include a game play display area 110 with indications of one or more set of numbers associated with one or more play levels with regards to a game of Alien Invasion. A player may select the set of numbers for a particular play level, for example, by providing an indication on an entry form (see FIG. 1A, discussed above), by choosing a pre-printed ticket (see FIG. 1C, discussed above), or via a quick pick. Alternatively, the player may select the set of numbers interactively via an interactive screen at a kiosk, or on a mobile phone, PDA, or personal computer. In this instance, the game play display area 110 includes a first set of numbers “3 1 4” for Level 1, a second set of numbers “6 8 10 15” for Level 2, and a third set of numbers “18 24” for Level 3. It will be appreciated that the range of numbers and/or play levels may vary according to the rules of the game. It will also be appreciated that a player may elect to have fewer than all of the levels of the wager that are made displayed on a ticket or an interactive screen at any one time, and may, depending on the rules, automatically be entered into multiple rounds by default, or only enter an additional round at the time when a winning ticket is redeemed for a prize. Moreover, the player may elect to play the different levels of the game in a single play session, or the player may elect to play the different levels of the game at different times, e.g., Level 1 on one day, Level 2 on the next day, and Level 3 on a third day.

The example ticket 100 may also include an amount wagered field 140, indicating the amount wagered on each level in a game. Alternatively, the amount wagered field 140 may indicate the total purchase price of the ticket.

The example ticket 100 may also include an authentication code 150, which may represent information that may be used to uniquely identify the ticket. In this example, numerical digits are used. However, it will be appreciated that other unique identifiers, e.g., letters or other human-readable symbols, or machine readable codes such as bar codes, may also be provided. With respect to the numeric digits of the present example, more digits or other authentication information may be provided for greater security. The authentication code 150 may include information required to authenticate the ticket when the ticket is redeemed. A machine-readable version of the authentication code 155 may also be provided on the example ticket 100. The machine-readable version of the authentication code 155 may be a bar code, e.g., a stacked linear bar code, a two-dimensional bar code or a PDF-417 bar code. A standard I2 of 5 or other standard bar code may be employed. It will be appreciated that other forms of machine-readable information may be included on the ticket, in place of the bar codes, e.g., magnetic strips or smart card capability. It will also be appreciated that the machine-readable code 155 may also include other information, e.g., a checking code that may provide sufficient information to identify whether the ticket is a winning ticket without providing sufficient information to authenticate the ticket. Such a checking code may be used at a checking station so that customers may test whether they have winning tickets.

The example ticket 100 may also include a date/time field 160, to indicate when the ticket was purchased or when the drawing for the game is to occur. Alternatively, the date/time field 160 may include the date and time of the drawing for a particular play level. The example ticket 100 may also indicate the game or games for which that ticket has been purchased. It will be appreciated that the customer may select the game or games to be played and that the customer may re-use the same ticket for more than one game and/or level of play.

The example ticket 100 may also include information not directly involved in the play of the game. For example, the example ticket 100 may include instructions 170 for playing the game and/or redeeming the ticket. Additionally, the instructions 170 may include a chart indicating the prize received depending on the level of play.

It will be appreciated that other information may be included in the example ticket, e.g., the name of the game 180, the identity of the organization sponsoring the game 181, as shown the “ABC Lottery”, and the identity of the agent selling the ticket 182, an identification number for the point of sale terminal that the ticket was sold from, additional advertising information, coupons, etc. Rules of the game and/or legal disclaimers may be printed on the ticket, e.g., on the reverse side. Additional security and authentication information may also be added, e.g., multiple layers, special marks, etc.

FIG. 2B illustrates an example electronic ticket 100′, according to a second example embodiment of the present invention. The elements labeled “′” are the same as or similar to the fields in the FIG. 2A, without the prime indicators, and similar variations as those described previously, e.g., with respect to FIG. 1, may also be employed. However, it will be appreciated that these elements may be modified to make them suitable for electronic display, as in FIG. 2B, as opposed to those illustrated previously with respect to printed tickets. The example ticket 100′ may be for a risk reward game, such as, the Soccer game described above with reference to FIG. 1B. The example ticket 100′ may be received in a variety of ways, as an email, via the WAP protocol, an SMS text message, or using a client-based interface program, such as a JAVA graphical interface program for the game. It will be appreciated that an entry represented by the electronic ticket may be received for a multiple successive instances of the game of chance. Additionally, multiple chances may be purchased in a single game.

The example electronic ticket 100′ may be depicted on a display screen. Alternatively it may be display as part of an email, on a web page, or in another electronic format.

The example ticket 100′ may include a game play display area 170′ with indications of one or more set of numbers associated with one or more play levels with regards to the game, here the Soccer game described previously. A player may select a set of numbers for a particular play level, for example, by providing an indication on an entry form (See FIG. 2B discussed below) or via a quick pick. Alternatively, the player may select a set of numbers via an interactive screen at a kiosk. In this instance, the display 170′ includes a first set of numbers “1 2 4” for an initial round, Level 1. Although it will be appreciated that the player could make selections in advance for multiple rounds in variant versions of the game, that is not what is illustrated here. In this regard, the holder of the exemplary ticket 100′, once the initial round has been completed, may have the option to redeem the exemplary ticket 100′ for a prize won in the first round or continue playing at Level 2. It will also be appreciated that the range of numbers and/or number of play levels may vary according to the rules of the game.

The example electronic ticket 100′ may also include an authentication code 150′, to uniquely identify the ticket. More digits may be provided for greater security. The authentication code 150′ may include information required to authenticate the ticket when the ticket is redeemed. A machine-readable version of the authentication code 155′ may also be provided on the example electronic ticket 100′. This machine readable code may be scanned directly from the screen of a mobile phone or PDA using a bar code scanner, or may be transmitted by the device as part of a network communication such as an email, text message, or other form of network communication. The machine-readable version of the authentication code 155′ may be a bar code, e.g., a stacked linear bar code or two-dimensional bar code. A standard I2 of 5 or other standard bar code may be employed. It will be appreciated that other forms of machine-readable information may be included on the ticket, in place of the bar codes, e.g., magnetic strips or smart card capability. It will also be appreciated that the machine-readable code 155′ may also include other information, e.g., a checking code that may provide sufficient information to identify whether the ticket is a winning ticket without providing sufficient information to authenticate the ticket. Such a checking code may be used at a checking station so that customers may test whether they have winning tickets. However, for an electronic ticket, it may be simpler to have a software function on the client device inform the player they hold a winning ticket, e.g., by sending a visual or audio signal, a special email, or the like.

The example electronic ticket 100′ may also include a date/time field 160′, to indicate when the ticket was purchased or when the drawing for the game is to occur. Alternatively, the date/time field 160′ may include the date and time of the drawing for each level, or alternatively for just the initial level. The example ticket 100′ may also indicate the game or games that the ticket has been purchased for. It will be appreciated that the customer may select the game or games to be played and that the customer may reuse the same ticket for more than one game.

The example ticket 100′ may also include information not directly involved in the play of the game. For example, the example ticket 100′ may include instructions for playing the game 110′ or for the use and/or redemption of the ticket. Additionally, the instructions may include a chart indicating the prize received depending on the level of play.

It will be appreciated that other information may be included in the example ticket, e.g., the name of the game 180, or additional advertising information, offers, etc. Rules of the game and/or legal disclaimers may be printed on the ticket, or in pop-up windows or hyperlinked. Additional security and authentication information may also be added, e.g., icons or other indications related to the use of secure Internet channel. It may also be useful to associate a player and/or device ID 184 with the ticket, e.g., a unique player identifier, or an identifier of the device such as a SIM id code for a mobile phone. This may be used to associate the game chance with the player or device, or with an electronic funds account, such a prepaid account associated with the player or device.

FIG. 2C illustrates another example ticket 100″, according to a third example embodiment of the present invention. The elements labeled “″” are the same as or similar to the fields in the FIG. 2A without the primes, and similar variations as those described previously may also be employed. The example ticket 100″ may be for a risk-reward game, such as the Battleship game illustrated previously, that uses a pre-printed entry form or play card. The example ticket 100″ may be received in a variety of ways, e. g., by presenting the pre-printed play card along with a payment as part of a request for a game entry from a cashier or establishment operator or by purchasing a ticket from a vending machine that generates such tickets after reading the pre-printed play card. Alternatively, it will be appreciated that the information provided to the player on the separate ticket 100″ illustrated here, could alternatively be provided by adding the information directly to the pre-printed play card described in FIG. 1C when they play card is tendered to enter the game, omitting information that would be duplicated.

However, different from FIG. 1A, the player entries 110″ in ticket 100″ include both a number and symbol guess at the drawing result, e.g., representing a simulated battleship-type board game coordinate. In addition to the other elements, the ticket 100″, may also include a retailer ID 182, that identifies where the ticket was obtained or the play card was activated, and a play card ID 183 that associates the ticket or receipt with the play card that the player used to request the game play. In this regard, the holder of the exemplary ticket 100″ may have the option to redeem the exemplary ticket 100″ or continue playing at Level 3.

The example ticket 100″ may also include an authentication code 150″, to uniquely identify the ticket. More digits may be provided for greater security. The authentication code 150″ may include information required to authenticate the ticket when the ticket is redeemed. A machine-readable version of the authentication code 155″ may also be provided on the example ticket 100″. The machine-readable version of the authentication code 155″ may be a bar code, e.g., a stacked linear bar code or two-dimensional bar code. A standard I2 of 5 or other standard bar code may be employed. It will be appreciated that other forms of machine-readable information may be included on the ticket 100″, in place of the bar codes, e.g., magnetic strips or smart card capability. It will also be appreciated that the machine-readable code 155″ may also include other information, e.g., a checking code that may provide sufficient information to identify whether the ticket is a winning ticket without providing sufficient information to authenticate the ticket. Such a checking code may be used at a checking station so that customers may test whether they have winning tickets.

The example ticket 100″ may also include a date/time field 160″, to indicate when the ticket was purchased or when the drawing for the game is to occur. Alternatively, the date/time field 160″ may include the date and time of the drawing for each level. The example ticket 100″ may also indicate the game or games that the ticket has been purchased for. It will be appreciated that the customer may select the game or games to be played and that the customer may reuse the same ticket for more than one game.

The example ticket 100″ may also include information not directly involved in the play of the game. For example, the example ticket 100″ may include instructions for playing the game or for the use and/or redemption of the ticket. Additionally, the instructions may include a chart indicating the prize received depending on the level of play.

It will be appreciated that other information 180″ may be included in the example ticket, e.g., the identity of the agent selling the ticket, an identification number for the point of sale terminal that the ticket was sold from, additional advertising information, coupons, etc. Rules of the game and/or legal disclaimers may be printed on the ticket, e.g., on the reverse side. Additional security and authentication information may also be added, e.g., multiple layers, special marks, etc.

### Alternative Example Game Ticket for a Lotto-Type Game

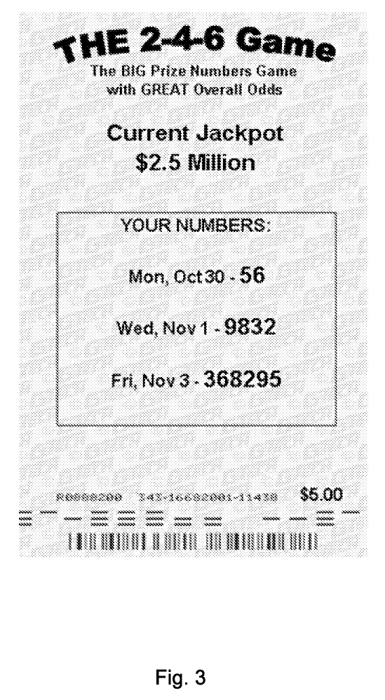

FIG. 3 illustrates an alternative example game receipt or game ticket, according to another example embodiment of the present invention. In this alternative, a player may enter and play in a variation of a convention Lotto-type lottery game, called for illustration here “The 2-4-6 Game”. The player may be provided with entries for the multiple rounds of the game ahead of time, with the rounds held had predetermined time intervals, e.g., every five minutes in an online draw game like Keno, or, as is shown in the illustrated ticket, a daily draw similar to a conventional Lotto, Pick 3 or Pick 4-type daily draw game. The illustrated ticket has pick numbers for each round, which may be selected by the player at the time of purchase or provided as a quick pick. It will be appreciated that, in variants, the same pick numbers could be used throughout, e.g., a single player selection of six numbers, that requires matching 2 in the first round, 4 in the second round draw, and 6 in the third round draw. In either case, the number of pick numbers that need to be matched in each round increases, decreasing the odds of success. This allows players to win smaller prizes, and cash out, or continue to play for a large life-changing prize at low odds. In this example, the player may cash their entry after each round, e.g., before a pre-determined deadline. Or, they may retain the ticket and automatically play the following round. Thus, the default is the player is entered in the succeeding round. In an alternative example, the player might need to take express action to enter each succeeding round. Because the odds of winning go down with each round, the amount of the prize won by successfully winning all the rounds can be made quite large, which may attract players who are interested in winning a very large, life-changing prize.

In some variations, the prizes for successive rounds may have progressive or pari-mutuel elements. For example, the final round “grand” prize might be a large fixed sum or share of all entries, which is divided among all the players who advance successfully through the various rounds and win the final prize. Alternatively, the size of the prize pool might be increased depending on the number of players who advance to play succeeding rounds, e.g., a fixed contribution for per player in the later rounds. Or, the largest prize from the final round may have a progressive element, in a manner similar to the popular Powerball game, where the prize increases with each game instance until the prize is won.

### Example Procedure for Playing a Game of Chance

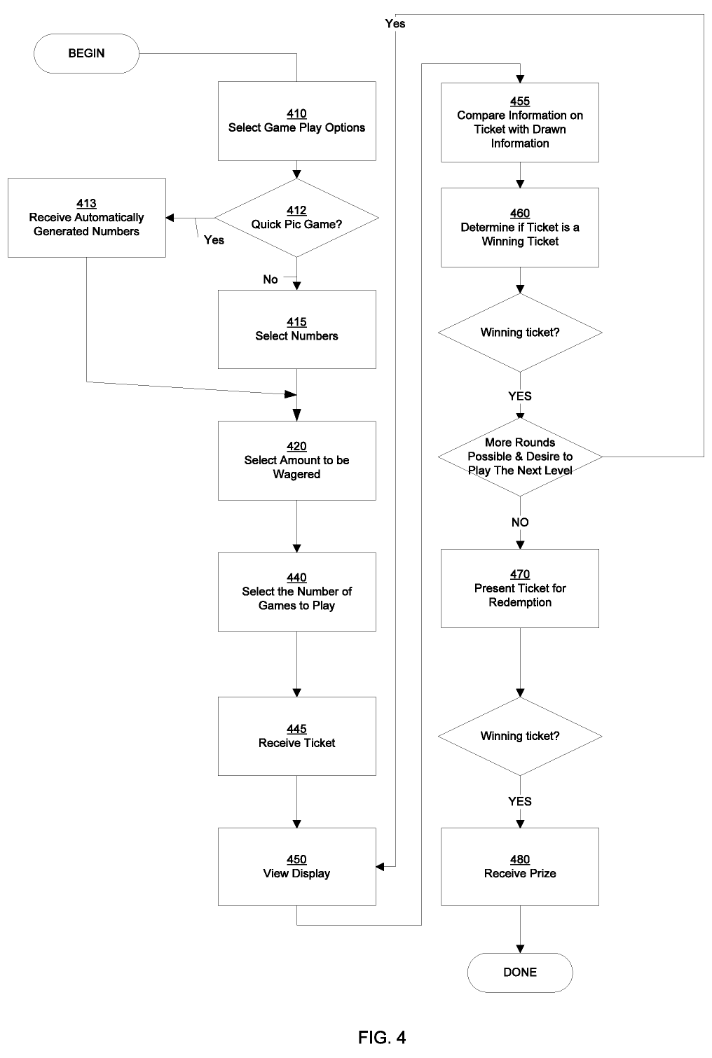

FIG. 4 illustrates an example procedure for playing a game of chance, according to an example embodiment of the present invention. In 410, a customer selects a game play option by marking an entry form, entering information on a machine, e.g., a personal computer, mobile phone, kiosk, or PDA, or by telling a clerk at an agent-operated terminal who may enter information for a customer at the terminal, or by activating or purchasing a pre-printed ticket with pre-printed selections. Game play options may include a game based upon a risk reward game, such as, for example, Alien Invasion, Soccer, or Battleship described previously, as well as other presentation themes, such as sports, racing casino games, popular board games, or other licensed properties. It will be appreciated that other games may also be included in the game play options. For the rest of the procedure, it will be assumed that a customer has selected to play the Alien Invasion game. In a system where system generated “quick pics” are provided, in 412 a customer's decision as to whether to choose their own numbers or rely on the system to make the selections may be made. If a customer chooses to play a quick pic game, the example procedure continues in 413 for a system-generated number pick; otherwise, the procedure for playing the game continues in 415. Similarly, where the customer has elected to play the game by selecting and activating a pre-printed game card, the example procedure may continue at 445, where the receipt may be generated based upon the number selections on the selected pre-printed game card.

In 415, the customer may indicate his picked numbers for a particular level of the game. For example, a customer may indicate three out of four possible numbers for a first level, five out of sixteen possible numbers for a second level, or two out of thirty possible numbers for a third level. It will be appreciated that the type and quantity of numbers picked may vary depending on, e.g., the rules of the game

In 420, a customer may select the amount to be wagered. For example, the customer may select the dollar amount that is to be wagered at a particular level of play. Here, the level represents the particular stage for the game depending on a previous level of play. For example, if a customer selects $5, then for the particular level of game played the customer would have a different chance at winning. In this regard, a customer may indicate a common dollar amount to be wagered for each level of play, or alternatively, a different dollar amount may be wagered for each level of play. Conversely, rather than indicating an amount for each level, the customer may indicate the total amount to be wagered for a single game regardless of game level.

Alternatively, a customer can choose to wager from pre-determined price or prize thresholds, e.g., they can be based on the amount they are willing to wager and those amounts may help determine the amount of the award for a win; or, alternatively, they can place bets based upon the amount they want to win. For example bet $2 in the first round to win $5, bet $5 in the second round to $25, and $25 in the third round to win $200. Or, alternatively, they may bet $3 in the first round to win $9, $9 in the second round to win $82, and $81 in the third round to win $349. This type of option may appeal to players with different play styles or budgets. In another alternative, players may partially redeem their prize, so, e.g., a player betting $3 and winning $9 in the first round, could choose to receive $4 as a prize and reinvest the other $5 in the second round bet described above.

In 440, a customer may select a quantity of games that can be played using the ticket. For example, if a customer wishes to play the same selected numbers for three games a customer may indicate so. A game may be each time information is drawn that allows a customer to determine whether a chance is a winning chance. For example, a ticket may be a winning ticket if all selected numbers on the ticket match a drawing or other set of randomly selected numbers to match. The customer may also indicate that they want to print out their Level 1 wager, and store the Level 2 and Level 3 wagers to be retrieved and used later, e.g., on a different day. The ticket may be modified to show this data as well.

In 445, a customer receives a ticket. The ticket may contain indications of the information selected in 410 to 440. The ticket represents at least one chance in a game. The information selected in 410 to 440 may be processed into a ticket by an operator of a ticket device or the process may be automated. If the process is automated, the information may be entered by the customer into a ticket machine that processes the information and generates a ticket. Or, in the case where the customer chooses from a selection of pre-printed ticket or selection card, the customer may activate or have the chosen pre-printed ticket or selection card activated.

In 450, a customer may view a display. The information on the display may include information regarding a winning set of numbers of a particular level of play. For example, the winning set of numbers may be represented on a television (TV) or other monitor or interactive video screen, such as, for example, an interactive kiosk, a cell phone or a PDA. At the drawing time, a winning set of numbers may be shown or highlighted. It will be appreciated that more than one approach may be employed to display or highlight the winning set of numbers. For example, each number of the winning set of numbers may be shown one at a time, or a group of winning numbers may be shown together with their corresponding game draw times. Where there is a cell phone or PDA used, the customer may be notified in advance of the upcoming drawing and/or receive news of the drawing after the drawing has been completed, e.g., by email or SMS text message.

In 455, a customer may compare the information on the ticket with information on the display. In particular, the customer may compare a drawn winning number to the numbers represented on the ticket. If the customer uses an interactive video interface, these comparisons can selectively performed by the customer, e.g., by revealing hidden boxes or random selections, in the manner of a video game, video poker game, or video slot machine.

In 460, a customer determines if a ticket is a winning ticket for a particular level of play. If the winning set of numbers for a certain level match the numbers displayed on the ticket for that level, the ticket is a winning ticket for that particular level of play. These may also be displayed in an interactive fashion, if the player uses an interactive video device to reveal the drawing outcome.

At this point, the customer may decide to either continue playing to the next level or redeem the ticket. If the customer wishes to continue playing to the next level then steps 450 to 460 are repeated (steps 410 to 445 may additionally be repeated if numbers not already selected for the next level). Otherwise, if the customer wishes to redeem the ticket, the procedure proceeds to step 470.

In 470, a customer presents a ticket for redemption. For example, the customer may present the ticket to the cashier or place it in a ticket validator. The gaming procedure may require tickets to be redeemed at the same establishment where they are sold, or may allow a ticket to be redeemed at a future time and at various locations. The ticket may be authenticated to determine whether the ticket is a valid winning ticket, e.g., if the ticket is a winning ticket and has not previously been redeemed. The authentication may be performed using an authentication code that uniquely identifies the ticket. Conventional schemes for authenticating ticket numbers may be employed, e.g., the authentication number may be used as part of a public key encryption system. The authentication may be performed by first ensuring that the ticket is a winning ticket. In some alternatives, e.g., where the player uses an interactive device, prize funds may be deposited directly to a player's electronic account.

In 480, if the ticket is a valid winning ticket, a customer may receive a prize for the winning ticket. The prize may be cash or anything of value, e.g., additional tickets. The prize may vary based upon the rules of the particular game, e.g. in a Keno-like example on the number of matching symbols, the quantity of the spot number, etc.

### Example Procedure for Facilitating the Play of a Game of Chance

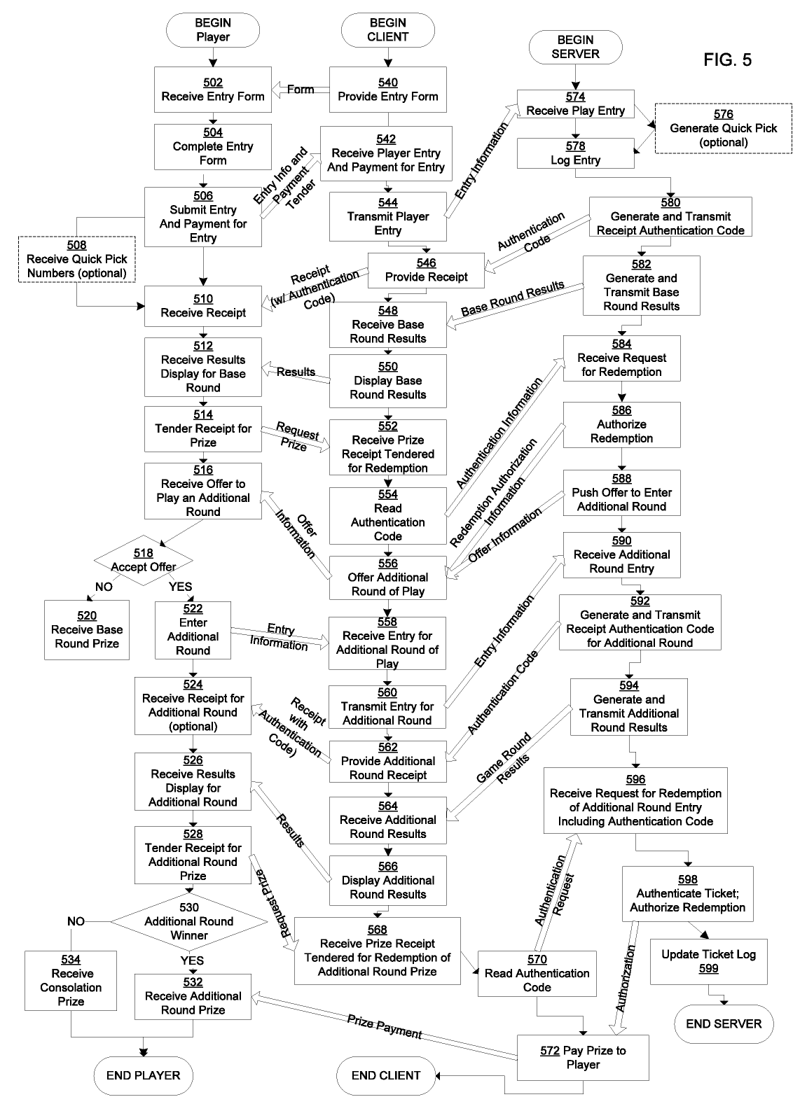

FIG. 5 illustrates an example procedure for facilitating the play of a game of chance, according to an example embodiment of the present invention For example, the example procedure may be for the operation of an online lottery game, such a modified Keno game or modified online Lottery drawing game. The example procedure is illustrated from the perspective of the player (column 1), from the perspective of a game terminal or “client” in a client-server system (column 2), and from the perspective of a server or host (column 3). While the procedure elements are divided between client and server, it will be appreciated that they could all be provided on a single system, or distributed over multiple computers in a distributed system in a different manner. In the flowchart, solid arrows represent flow of control, while the larger hollow arrows represent communication of data between the various actors providing the flow of control. It will be appreciated that the example procedure is not limited to the particular actors described in the example, and that the various procedure elements may be redistributed between the same and/or different actors.

In 502, an entry form may be received, e.g., by the player. The entry form may identify the actions that a player must take to enter the game, as well as allowing the player to provide information regarding their game entry such as what game they are entering, when they are entering, information identifying the player, and the players choices for the game, e.g., numbers or other symbols the player guesses will be drawn in a drawing game, or the players indication that entry choices should be chosen for the player, e.g., a quick pick. The entry form may be, e.g., a paper play slip, or it may be an electronic entry form provided to the player on a dedicated kiosk, or on the player's own personal device such as a PDA, personal computer or mobile phone. In an alternative example, a variety of pre-printed entry forms with pre-made selections may be freely provided, e.g., those illustrated previously. A player can then select one of the pre-printed entry forms and present it for activation in order to enter the game.

The entry form may be received from a client system, e.g., an agent operated terminal where the slip is distributed automatically by the terminal or alternatively handed out by the agent operating the terminal, an unattended kiosk that prints or dispenses the receipt, a web server, or even from the player's own computer system or mobile device, if that device acts as a client for game operations. The client may provide the entry form in 540, described below. In some alternative examples, a set of pre-printed entry forms or tickets may be provided, and the player may choose a pre-printed entry or pre-printed ticket to be activated from the set of available pre-printed forms; in which case the selection of the entry numbers may be subsumed in the presentation of the pre-printed form or ticket for activation.

In 504, the entry form may be completed. (With pre-printed entry forms or tickets, the player may simply choose a selected pre-printed form or ticket from the available selections.) The player may indicate their entries in the game, the amount wagered, the number of plays they want to make, the particular game or drawing they want to enter, if they desire a quick pick, and other required and/or optional information for the game.

In 506, the player entry and payment associated with the player's wager may be submitted, e.g., cash paid to a clerk, cash deposited in a vending machine or kiosk, credit or debit card, money authorized to withdrawn from a pre-paid account, or a prize credit from a previous win in the same or a different game that is used to allow entry in a further game play. (The entry may be received, e.g., by the client in 542 described below.)

In 508, optionally, if a “quick pick” has been selected or the player has otherwise indicated that their entries should be selected for them, quick pick numbers may be received, e.g., by the player on their receipt or ticket.

In 510, a receipt may be received, e.g., by the player from the client. The receipt may be, e.g., a paper and/or electronic receipt, indicating their entries, and, e.g., the particular time and date of the game they have entered, a drawing number, and/or other information regarding the game play in which they have been entered. With the alternative of pre-printed tickets, the chosen ticket may simply be activated, and optionally have an authentication code printed on it or on a separate receipt.

In 512, the results for a base round may be received. These may be received by being viewed on a public or private display, by email, by a broadcast medium such as television or radio, by accessing an Internet web site that gives results, or through a variety of other approaches.

In 514, the receipt may be tendered for a base round prize. In some variants of the game, the player may be entered in a succeeding round by default. In other variants, the player may not have the ability to enter a succeeding round until the player presents their receipt for redemption of the base round prize.

In 516, in response to the tendering of the receipt for the base round prize, and assuming the base round receipt is an authentic ticket that is entitled to a prize that may be wagered in the subsequent round, the player may receive an offer to play an additional round of the multi-round game, e.g., to put their prize at risk for a second larger prize. In other variants, the offer may be provided ahead of time.

In 518, the offer to play an additional round may be accepted by the player. In some variants, the indication that the player will enter an additional round may occur by default, e.g., by the player failing to redeem their winning ticket for the base round by a predetermined deadline, in which case they are automatically entered in the following round of the game.

In 520, if the offer to play an additional round is rejected by the player, the player may receive the base round prize to which they are entitled, assuming the ticket was previously authenticated as a valid winning ticket.

In 522, the player may enter an additional round of the game, placing their prize for the base round at risk in the additional game round. Alternatively, the player may have the option to claim part of their prize, while putting the remainder at risk in the following round.

In 524, a receipt for the additional round entry may be received. This may be a separate receipt, or additional information added to or associated with the receipt for the base round entry. Alternatively, no additional information may be received, however this may have the disadvantage that there is noting that the player can use to prove they have entered the following round.

In 526, the results for the additional round may be received. This may be similar to the display of results for the initial round.

In 528, if the results for the additional round indicate the player holds a winning entry for the additional round, the receipt for the additional round may be tendered for a prize.

In 532, a prize for the additional round may be received, assuming, as shown in 530, that the tendered receipt has been authenticated as a valid winning ticket for the additional round. This prize may be larger than the base round prize.

It will be appreciated that the process of entering additional rounds may be repeated for additional cycles in some example procedures. The prize for winning the additional round will generally be larger than the base round prize, providing the player a larger return. Although, in some cases, smaller consolation prizes may be provided if the player is not entitled to a larger prize. It will be appreciated that, if a prize is won, rather than paying the prize to the player, the entire procedure could be repeated for one or more additional rounds of play, with the potential for much longer odds and much larger prizes.

In 534, if the additional round is lost, a consolation prize may be received in some example procedures. This prize may be smaller than the base round prize.

In 540, an entry form may be provided, e.g., to a player who requests one, or even unsolicited as part of a promotion. This may be accomplished with a variety of approaches, e.g., displaying an electronic form for completion by the player, providing a touch screen interface for player selections, printing a paper entry form, dispensing a pre-printed entry form, or providing pre-printed entry cards for player selection. Play options may be provided, e.g., by providing them on the entry form to a game customer, or by providing an on-line form on a selection machine or other display terminal. The play options may also be provided upon request, e.g., by the customer adjusting options on a PC or mobile phone client. It will be appreciated that a customer may use an entry form to select information for the play of the game.

In 542, the player's entry form and a tender of payment for a game entry may be received. The entry form information may be read, e.g., directly from an input device for an electronic form, by scanning player marks on an entry form, by reading a bar code on a pre-printed play card, or using other approaches. Payment may include, e.g., cash paid to a clerk or deposited in an automated cash acceptor, credit card, debit card, authorization to take money from a prepaid account, using a prepaid card or smart card, or crediting the player with prize money from a previous winning game result.

In 544, the player's entry may be sent, e.g., to a server that logs and records player entries in the game. The player's entry may include some form of authentication and nonrepudiation, such a digital signature or passcode for access to an account.

In 546, a receipt or ticket may be provided to the player. The receipt may be paper or electronic. Included in the receipt may be a serial number, authentication code, or other security elements received from the operator or server, or generated at the client. The receipt may also include information indicating the player's game entry, as well as other information described previously.

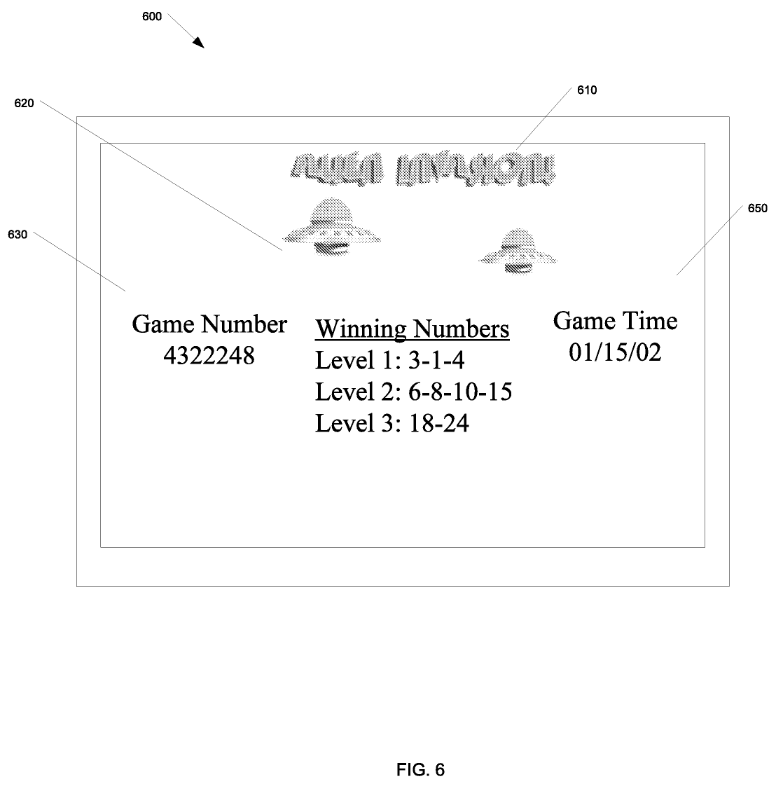

In 548, results for the additional round may be received, and in 550, the results may be displayed. The results may be separate from the presentation or may be supplied together. So, for example, a numerical result may be supplied from the server, and the client may synthesize an animated race or other game presentation that represents the numerical result. Game play information may be displayed on a display terminal in the form of, for example a set of winning numbers and associated games. In this regard, more than one approach may be employed to display or highlight the winning numbers. Example display screens are shown in FIGS. 6, 7, and 8. The display may be configured to display a corresponding drawn winning number(s) for each level of the game. The drawn winning numbers may be depicted as corresponding with a particular game time. The results may also be displayed on a public video display, by email, over the Internet via a web display, on a user's computer, mobile phone, or other device, or in any other manner that effectively (and preferably entertainingly) communicates the game results to the game player or players.

In 552, a tender of a winning game receipt may be received, e.g., from a player. In this regard, the ticket may be tendered, to a cashier or attendant, who scans or enters information from the ticket, or via an automated point of sale system by inserting it into an automatic reader, or it may be submitted electronically using an email, text message, or web server. Any other approach for the player to claim their prize may also be employed.

In 554, an authentication code or other identifier that securely identifies the chance for which the prize is being claimed may be read from the winning game receipt. The authentication code and/or other information may be transmitted to obtain authorization to redeem the ticket, e.g., to determine that the ticket presented for redemption is a valid winning ticket that has not already been redeemed, and to confirm the amount of the prize. In a cashier-operated client terminal, an indication may be provided that the cashier should redeem the tendered ticket, e.g., by displaying a prompt on a redemption system display. The amount to be paid may be displayed to the cashier, and/or directly to the person redeeming the ticket. It will be appreciated that this amount may be printed on a customer receipt. This indication may indicate both that the ticket should be redeemed and the amount for redemption. Alternatively, in an automated system, the ticket authentication procedure may initiate a ticket payment procedure automatically, once the ticket has been validated. It will be appreciated that if the ticket is not authentic, or is not a winner, it will not be redeemed or used to enter another round. It will also be appreciated, that as is conventional, very large prizes may be diverted, to be redeemed at a more secure location where the winning ticket can be subject to greater scrutiny.

In 556, assuming the ticket is an authenticated winner, the player may be offered the chance to participate in an additional risk-reward round of play, placing their prize, or a portion of their prize, at risk for the chance of a larger reward. It will be appreciated, that the decision to enter an additional round may be the default in some examples, and that the player automatically is entered in the next round following a win, unless they choose to terminate the game before the next round begins.

In 558, an entry into the additional round may be received. This entry may merely be an acknowledgement that the additional round is to be entered, or may also include additional entry information, such as additional guess information for a drawing type game. In 560, information indicating the player's entry into the additional round, including any additional entry information, may be transmitted.

In 562, additional receipt and/or authentication information may be received. In 564, the additional receipt information may be transmitted to the player, e.g., by printing an additional receipt, sending additional confirmation information electronically, etc. In 566, additional results for the additional round may be received and displayed to the player. In 568, a tender of a winning receipt for the additional round may be received. The authentication code may be read in 570, and transmitted for validation. Assuming the ticket is a valid, winning ticket that has not been already redeemed, a prize may be paid to the player in 572. It will be appreciated that the additional round portion procedure may be repeated multiple times for games that have more than two rounds. It will also be appreciated that the entire procedure may be completed where the player has entered the game for multiple instances. The entire procedure may be conducted simultaneously for multiple players, and as mentioned previously, in some implementations, the same draw may be used for different rounds of play for different players.

After 572, the example procedure for a client may be completed, although it may be repeated for additional players, games, partially repeated for additional rounds of the same multi-round game.

In 574, information indicating player entry may be received, for example at a lottery game server. At 576, if the player has requested a quick pick, random entry information for the player may be selected. At 578, the entry may be logged, e.g., in a ticket file or entry file. In games where the player is not anonymous, the entry may be associated with the player in the system, e.g., using a player ID. In 580, authentication information confirming the player's entry may be generated, for example using conventional public-key cryptography methods used in lotteries, and may be transmitted responsive to the player entry for inclusion in the player's game receipt.

In 582, some form of randomization may be used to determine the results for an initial game round. This may include computer pseudo-random number generation, physical randomization such as drawing balls or tokens, sampling real world events, such as race results, or other conventional approaches to generating random outcomes for game results. The results may then be transmitted, so that they may be displayed to the player or players at the client.

In 584, a request for redemption of a game entry, e.g., including a ticket identifier and authentication code, may be received, e.g., from a client such as a lottery redemption terminal, or from the player's own personal computer or mobile phone.

In 584, the request for redemption may be authenticated, e.g., using conventional public key methods and information from the entry or ticket log. In 586, assuming the request is for a valid winning ticket, authorization may be transmitted. It will be appreciated, that in some authentication schemes, an encrypted information may be transmitted and dealt with at the client, which conducts the authorization based on the received information. In 588, an offer to enter an additional round may be transmitted. Alternatively, the offer may be triggered at the client, or may be a default, absent a player's withdrawal from the multi-round game.

In 590, information indicating that the player has opted to participate in the additional round may be received. This may be received together with additional game entry information, in variants where the player chooses additional entry information at the time of entering the additional round. It will be appreciated that, in games where the entry into the additional round is a default, the information may simply be the absence of a request by the player to redeem their winning ticket for the earlier round by a predetermined deadline.

In 592, authentication information for the additional round entry may be generated and transmitted. In 594, random results for the additional round may be generated. These may be transmitted to the client for display to the player. In 596, a request for redemption of a winning receipt in the additional round may be received. The request may include authentication information from the receipt. After authenticating the ticket as a valid winning ticket, authorization to redeem the ticket may be transmitted, e.g., to the client, in 598. In 599 the ticket log may be updated to reflect that the ticket has been redeemed, e.g., by marking the ticket as “redeemed” in a winners file. Updating the ticket log to reflect that a ticket has been tendered for redemption may prevent the same ticket from being redeemed a second time at a later date.

It will be appreciated that other actions may be included in the example procedure for authentication and payment. For example, electronic payment may require different procedures. Extra security measures may be provided for large prizes, or old tickets, or tickets that were sold at different establishments than the one redeeming the ticket.

In one alternative procedure, rather than providing players with a prompt or offer to enter the risk-reward game, the player may be automatically entered in successive rounds of the risk-reward game as a default. If the player cashes their winning ticket from a round, they are not entered in the subsequent round. If they do not cash their ticket, they may be automatically entered in the next round.

In another example procedure, the prizes may depend on the number or fraction of players that elect to proceed to a round (or that choose not proceed). The largest prize or group of prizes may have a progressive element, so that the prize increases for each game entry, or for each instance of the game where the large prize is not won by a player.

### Example Display Terminal Screen

FIG. 6 illustrates an example display terminal screen 600 according to an example embodiment of the present invention. The display terminal screen 600 may be configured to display information for the play of a game. It will be appreciated that the display terminal hardware may be the same type of display terminal currently used in video games, e.g., a television.

The display terminal screen 600 may be configured to display the name of the game 610. In this instance, terminal screen 600 is configured to display “Alien Invasion”. Additionally, other information may be displayed such as the rules of the game, advertisements, etc.

The display terminal screen 600 may be configured to display a game number 630 to indicate a particular game about to be played. For example, in FIG. 6, the game number is 4322248.

The display terminal screen 600 may be configured to display one or more winning numbers via a simulated display of alien invaders. For example, periodically, say every few minutes, one or more winning numbers may be generated. In this regard, the winning numbers may be associated with a particular level of the game. For example, in this instance, the winning numbers for Level 1 are “3 1 4”, the winning numbers for Level 2 are “6 8 10 15”, and the winning numbers for Level 3 are “18 24”. The winning numbers may also represent an aspect of the game, in this instance, for example, the winning numbers may represent a quantity of matching alien spaceships. It will be appreciated that the range of winning numbers and/or associated characteristics of winning numbers may be configurable accommodate a particular lottery need or to adjust the payout odds. For example, the range of winning numbers may be increased.

The display terminal screen 600 may be configured to display a game time field 650 to indicate the date and/or time of the present game. The game time field 650 may also indicate the time remaining until the next game is to be played.

It will be appreciated that the display terminal screen 600 may be configured to display additional information. For instance, information regarding the previous game, the number of winners of the previous game or advertising information may be displayed. It will be appreciated that one skilled in the art would know how to configure a display terminal to display winning numbers.

### Second Example Display Terminal Screen

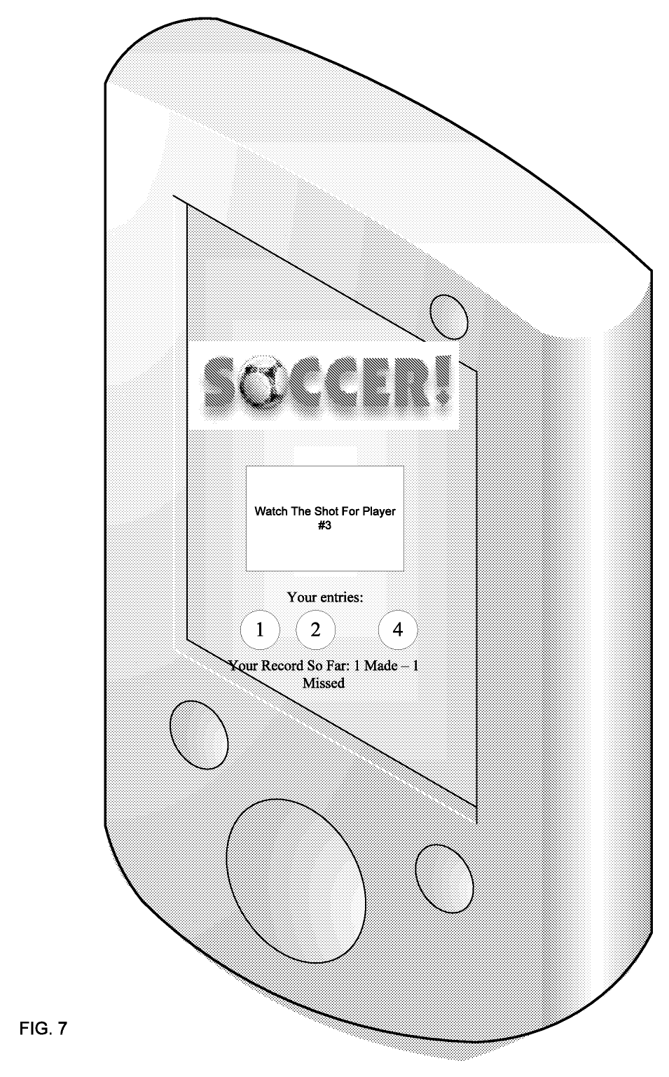

FIG. 7 illustrates a second example display terminal screen 700 according to an example embodiment of the present invention. The display terminal screen 700 may be configured to display information for the play of a game on a player's personal computer, mobile phone, or as illustrated PDA. Here, the Soccer Game name is displayed, along with player's entry numbers. Prior to the display all the results may be determined; then an appealing animated presentation of the results may be made. For each number in the population (10 in the Soccer example), a simulated penalty kick animation may be shown for that player. If the number of the shooter is one of the randomly drawn numbers, the shooter in the animation makes the shot, otherwise they miss. Also shown on the screen is a running count of the player's results, for instance after 2 shots, this screen shows that one of the player's entry numbers has been selected (and the shooter has made the shot) and 1 of the shooter's entry numbers has not been selected. In this manner, the game player, may receive an entertaining interactive display of the game results, that may be more appealing than a conventional numeric display. At the end of the game, and/or at regular intervals, the cumulative results may also be displayed, e.g., in a tabular form.

While this example display screen is shows a soccer game display shown on a PDA, it will be appreciated that a similar presentations may be made on many other types of displays, e.g., big screen TV displays in bars or other social gathering places, personal computers, mobile phones, over the Internet, etc. It will also be appreciated that an almost unlimited number of different presentations may be used to show the game results, e.g., a simulated horse or car race, sports events, board games, casino games, etc.

### Third Example Display Terminal Screen

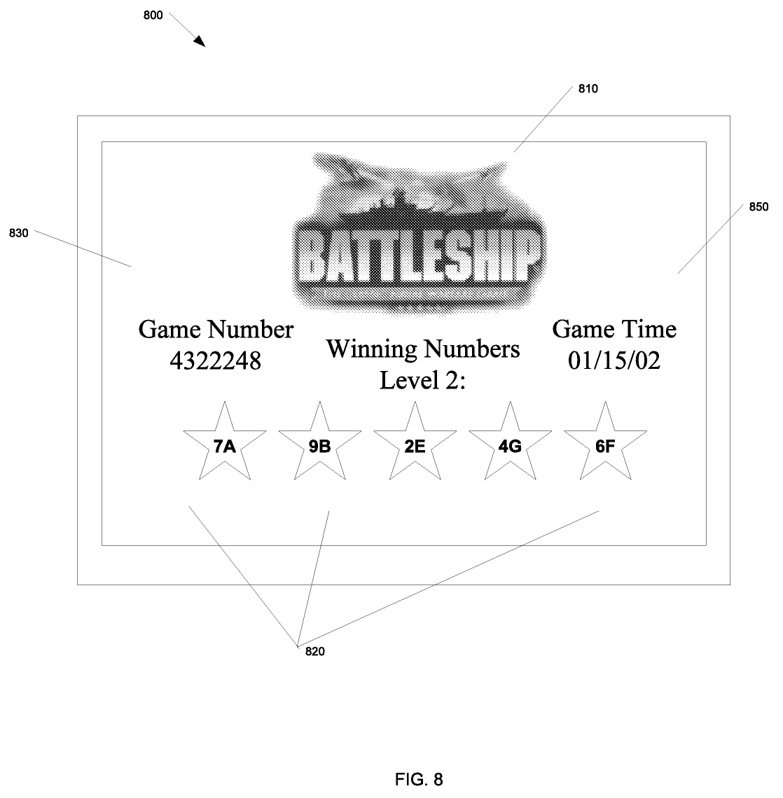

FIG. 8 illustrates a third example display terminal screen 800 according to an example embodiment of the present invention. The display terminal screen 800 may be configured to display information for the play of a game. It will be appreciated that the display terminal hardware may be the same type of display terminal currently used in lottery games, e.g., a television.

The display terminal screen 800 may be configured to display the name of the game 810. In this instance, terminal screen 800 is configured to display “Battleship”. Here the display include number-symbol pairs, rather than just the numbers displayed in the example display of FIG. 6. Additionally, other information may be displayed such as the rules of the game, advertisements, etc.

The display terminal screen 800 may be configured to display a game number 830 to indicate a particular game about to be played. For example, in FIG. 8, the game number is 4322248.

The display terminal screen 800 may be configured to display the generation one or more winning numbers via a simulated Battleship game. In this regard, the winning numbers may be represented, for example, by stars 820. The draw may occur, for example, periodically, say every few minutes, in which the winning numbers are generated. In this regard, the winning numbers generated may correspond to a different level of play. For example, in this instance, the winning numbers for Level 2 are “7A 9B 2E 4G 6F”. Depending on the rules of the game, the player might win if they match all the letter number pairs, match a certain number of letter-number pairs exactly (e.g., at least 3), or match a certain number of letters and/or numbers for a smaller prize—e.g., a consolation prize might be won if any three letters or three numbers are matched, even if the exact pairs are not matched. It will be appreciated that numerous other schemes for determining winning may be employed to produce a wide variety of odds and potential payouts.

The winning numbers may be selected, for example, from a range of number-symbol pairs corresponding to grid coordinates in the battleships game. The winning number-symbol pairs may also correspond to an aspect of the game, in this instance, for example, the winning numbers may represent the selections that cause hits on enemy ships. Alternatively, the drawing may represent shots made by an enemy, and the player's entries the locations of the player's ships. If the player's ships are all missed, or a certain number of the player's ships are missed, the player wins. It will be appreciated that the display 800 may be configurable to adjust the range of winning number-symbol pairs.

The display terminal screen 800 may be configured to display a game time field 850 to indicate the date or time of the present game. The game time field 850 may also indicate the time remaining until the next game is to be played.

It will be appreciated that the display terminal screen 800 may be configured to display additional information. For instance, information regarding the previous game, the number of winners of the previous game or advertising information may be displayed. Theme-based animations, for example warships shooting or being sunk could also be displayed to improve the entertainment value of the game.

### Example Game Chart of Payouts

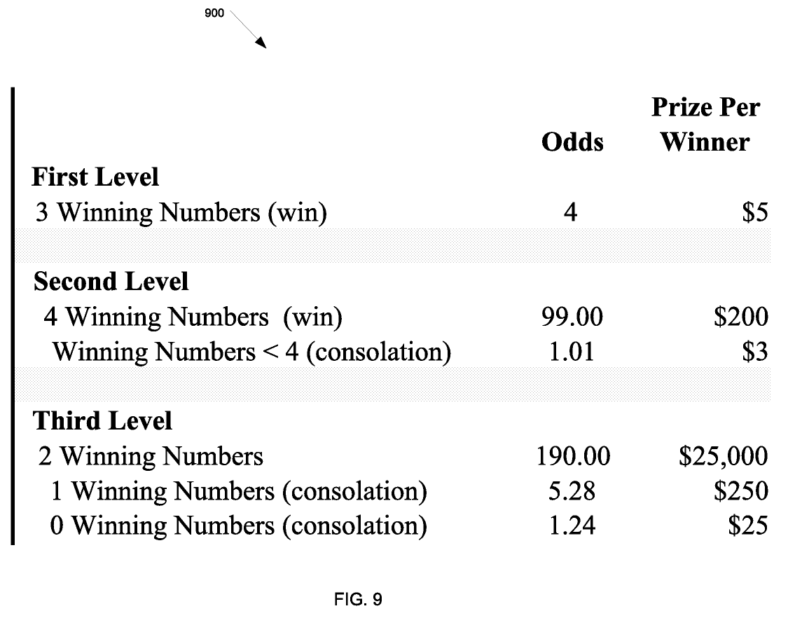

FIG. 9 illustrates an example chart 900 for determining whether a chance is a winning chance and if so the amount that may be won by the chance. This example chart may be printed on a ticket or made available to customers who purchase tickets. To determine whether a chance is a winning chance and if so the amount that may be won a ticket holder must know the bet type. The example chart is for a $1 chance. Similar charts may be provided for each amount of chance. It will be appreciated that the payouts may be pari-mutuel based on fixed odds and/or total amount wagered in a particular venue and/or region.

### Example Ticket Log

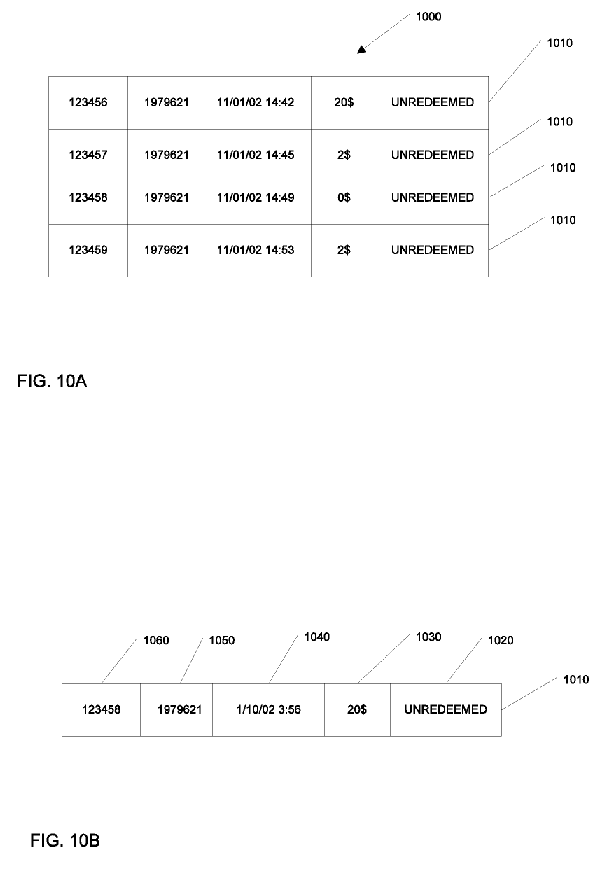

FIG. 10A illustrates an example ticket log 1000, according to an example embodiment of the present invention. The example ticket log 1000 may be used to keep track of tickets that have been sold, as well as whether sold tickets have been redeemed. The example ticket log 1000 may include a plurality of entries 1010, each entry corresponding to a ticket that has been sold. It will be appreciated that the ticket log, although illustrated as a table, may be stored in a variety of conventional data structures, e.g., as a linked list, or a custom-designed object. It will also be appreciated that the ticket log information may be incorporated in other data structures, rather than as a separate log, e.g., if the prize pool were stored in a relational database, the information may be stored in the prize pool may be split in multiple tables in a way that allows the information to be accessed as a log using conventional database queries.

FIG. 10B illustrates an example entry 1010 from the example ticket log, according to an example embodiment of the present invention. The example entry 1010 may include a plurality of fields that provide information about a particular ticket that has been sold. The example entry 1010 may include a ticket number 1060 that uniquely identifies a ticket that has been sold. For example, the ticket number 1060 may be an authentication code.

The example entry 1010 may include a game field 1050 to indicate a particular game or games that the ticket is associated with.

The example entry 1010 may include a time field 1040 to indicate the time the corresponding ticket was sold.

The example entry 1010 may include a prize field 1030, to indicate the amount that will be paid upon the ticket redemption. This amount may be calculated based on the ticket information and the display information. In the event that a ticket is for multiple chances in a single game or multiple games then the prize field 1030 may represent the total amount won by a ticket (the total amount won by each chance in each game).

The example entry 1010 may include a redemption field 1020 to indicate whether the ticket has been redeemed, and if it has when the redemption occurred. It will be appreciated that the ticket log entry may include other fields not shown, e.g., an indication where or by whom the ticket was sold or redeemed, the value of the authentication code for the ticket, price information for the ticket, an indication of the symbols to be displayed for that game.

### Example Lottery Terminal System

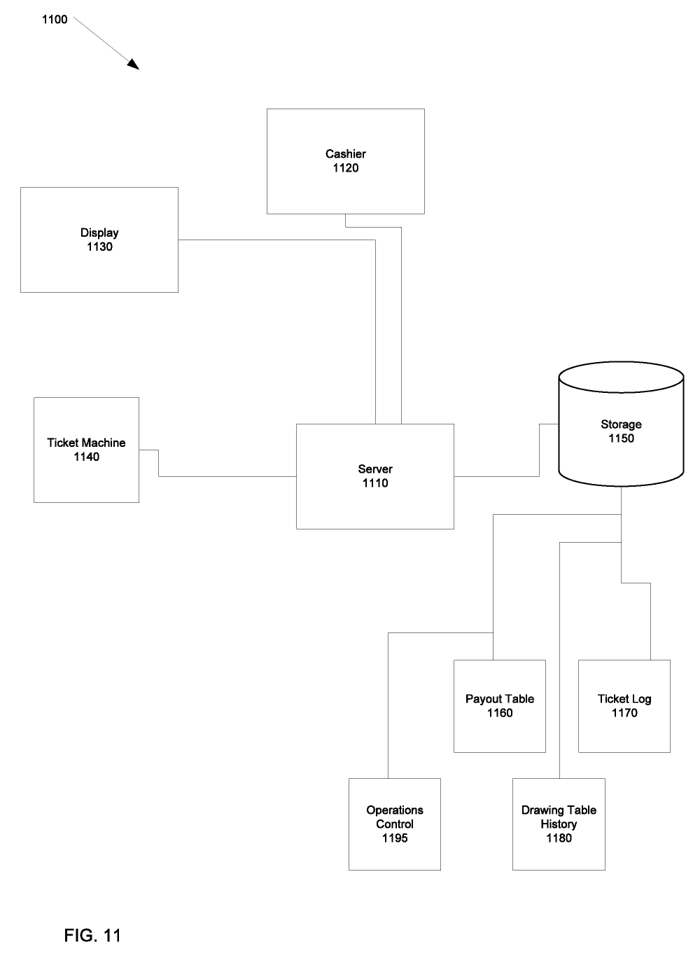

FIG. 11 illustrates an example lottery terminal system 1100 in logical view according to an example embodiment of the present invention. The example lottery terminal system may include one or more ticket machines 1140, one or more cashier machines 1120, and one or more or display devices or monitors 1130.

The example lottery terminal system 1100 may include a server 1110. The server 1110 may include a conventional microprocessor or custom designed control circuitry. The server 1100 may be in communication with the ticket machine 1110, cashier machine 1120, and display device 1130. The server 1110 may be used to control the operation of the other components of the lottery terminal system, e.g., by executing a control program that facilitates the play of a game of chance. The server 1110 may be configured to control the lottery terminal system 1100 in carrying out procedures for facilitating the play of a lottery game, generating drawn numbers, generating drawn symbols, and authenticating and paying winning lottery tickets, as were described above. In example systems where the player uses an interactive device to enter and/or receive game results, the server may include or be in network communication withy a network interface. The network interface, e.g., a web server and/or other type of transaction processor may be accessible from a player's personal computer, PDA, or mobile phone, may facilitate communication with the interactive devices used by the players. Where electronic funds are permitted by law for wager and are used in the system, an electronic funds interface may provided as part of or in communication with the server. The electronic funds interface may facilitate payments from and/or prize credits to an electronic funds system, such as pre-paid player accounts, bank EFT transfers, or credit card transactions.

The example lottery terminal system 1100 may include a storage subsystem 1150. The storage subsystem 1150 may include RAM, ROM, disk, optical disk, flash memory, or other conventional storage media. The storage subsystem 1150 may be a separate component from the server 1110, or may be included as part of the server 1110.

Stored in the storage subsystem 1150 may be programs and data used to control or facilitate the play of lottery games. A game operations control program 1195 may be used to control the sale and redemption of gaming chances in the procedures for playing and facilitating the play of a lottery game that were described previously. The game controller may include a random number generator of some type, e.g., a computer software pseudo random number generator, a similar type of generator provided in hardware or firmware, access to a secure random number generator outside the system itself, e.g., a utility or service that provides the results of random external events, such as ball drawings used in conventional Lotto type games or pseudo-random numbers generated on another computer system, or access to other information that while not technically random, are unknowable in advance and effectively random for the purpose of the game, e.g., reference to particular sports or financial information, such as the last (least significant) digit in the total stock sales on the New York stock exchange, or the last (least significant) digit of the total number of pitches thrown in all the major league baseball games on a particular day. Where “random numbers” are referred to in the present application, it should be understood, unless expressly indicated otherwise, that any of the above approaches to random number generation are intended to be included. It is also appreciated that, the random numbers can be used to determine game outcomes; however, the determination may be done either on the central system, at a client system or elsewhere—thus the system generating the random numbers may, but need not, map these numbers into corresponding game outcomes. The storage subsystem 1150 may also include a ticket log 1170 that may be used to record the sale of tickets and facilitate procedures for redeeming tickets. The storage subsystem 1150 may further include a drawing table history 1180, that may be used to record drawing information for all drawings that have occurred, e.g., record drawn symbols and drawn numbers for each previous game.

Payout table 1160 may provide information needed to determine prizes based on various game outcomes in accordance with the result of a particular game. For example, the prize for various bets, spot numbers, and number of selections matched may be stored so that the appropriate prize can be determined once the outcome of a drawing is determined. While called a “table”, it will be appreciated that any convenient data structure may be employed to provide the table, and that the table is not limited to a rectangular array. In some alternative examples, particularly in a single player game, rather than randomly generating the draw numbers, random selections from the payout table may be chosen, and then a presentation reflecting the desired outcome may be constructed.

It will be appreciated that the programs, prize pool, and ticket log need not be located in a particular storage subsystem, e.g., they could reside directly on the server. It will also be appreciated that other elements may be included in the example lottery terminal system, e.g. operations control program, security, auditing capabilities, etc.

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods games and procedures.

It will further be appreciated that the above-described methods, games, and procedures may be provided using the systems disclosed herein, or on other types of systems. The method claims of the application, unless expressly limited in the language of the claims, are not intended to be read to require particular actors or systems performing particular elements of the claimed methods.

### Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method for facilitating the play of a multi-level game of chance, comprising:
receiving information indicating a player's entry in the multi-level game for a base round, the entry including at least one of a player-selected set of entry numbers or a quick pick set of entry numbers;
providing a receipt to the player including a representation of the player's entry numbers for the base round of the multi-level game, the receipt being at least one of an electronic ticket or a paper ticket;
after entering the player in the base round of the multi-level game, randomly determining a set of winning draw numbers for the base round of the multi-level game;
displaying the winning draw numbers for the based round to the player on a video display;
determining whether the player entry is a winning entry in the base round of the multi-level game based, at least in part, on a comparison of the player entry numbers and the winning draw numbers for the base round;
conditioned on the player winning the base round of the multi-level game, offering the player a choice between receiving a base prize and continued play of the multi-level game for an additional round;
responsive to the receipt of information indicating the player's choice to receive the base prize, awarding the base prize to the player and ending the player's participation in that instance of the multi-level game;
responsive to the receipt of information indicating the player's choice to continue play of the multi-level game for the additional round, entering the player in the additional round of the multi-level game;
after entering the player in the additional round of the multi-level game, randomly determining an additional set of winning draw numbers for the additional round of the multi-level game;
displaying the additional set of winning draw numbers to the player on a video display;
determining whether the player entry is a winning entry in the additional round of the multilevel game based on a comparison of the player entry numbers and the additional set of winning draw numbers; and
conditioned on the player winning the additional round of the multi-level game, awarding the player a larger prize of greater value than the base prize.

2. The method of claim 1, further comprising:
conditioned on the player losing the additional round of the multi-level game, at least one of awarding the player no prize for that instance of the multi-level game or awarding the player a consolation prize that is less in value than the base prize in the multi-level game.

3. The method of claim 1, further comprising:
responsive to the player winning the additional round of the multi-level game offering the player a choice between receiving the additional prize and continued play of the multi-level game for a second additional round;
responsive to the receipt of information indicating the player's choice to receive the additional prize, awarding the additional prize to the player and ending the player's participation in that instance of the multi-level game;
responsive to the receipt information indicating the player's choice to continue play of the multi-level game for the second additional round, entering the player in the second additional round of the multi-level game;
after entering the player in the second additional round, randomly determining a second additional set of winning draw numbers for the second additional round of the multi-level game;
determining whether the player entry is a winning entry in the second additional round of the multilevel game; based on a comparison of the player entry numbers and the second additional set of winning draw numbers; and
conditioned on the player winning the second additional round of the multi-level game, awarding the player a second larger prize that is greater in value than the larger prize of the additional round.

4. The method of claim 3, further comprising:
conditioned on the player losing the second additional round of the multi-level game, at least one of awarding the player no prize for that instance of the multi-level game or awarding the player a consolation prize that is less in value than the larger prize of the additional round in the multi-level game.

5. The method of claim 1, further comprising:
providing a set of preprinted game cards, each including a respective set of entry numbers; and
receiving information indicating a player selection of one of the set of preprinted game cards, wherein the information indicating a player's entry is determined based on the information indicating a player selection one of the set of preprinted game cards and the player's entry includes the respective set of entry numbers from the player's selected game card.

6-7. (canceled)

8. The method of claim 1, wherein
the player's choice to continue play of the multi-level game rather than receive the base prize is indicated by the failure of the player to redeem a winning ticket for the initial game round before a predetermined deadline.

9. A method for facilitating the play of a multi-level game of chance, comprising;
receiving information indicating a player's entry in a base round in the multi-level game of chance;
providing a receipt to the player, the receipt including a representation of the player's entry for the base round of the multi-level game;
randomly determining a set of winning entries for the base round of the multi-level game; and
determining whether the player's entry is a winning entry in the base round of the multi-level game based, at least in part, on a comparison of the player's entry and the winning entries for the base round;
conditioned on the player winning the base round of the multi-level game, offering the player a choice between receiving a base prize and continued play of the multi-level game;
responsive to the receipt of information indicating the player's choice to receive the base prize, awarding the base prize to the player and ending the player's participation in that instance of the multi-level game;
responsive to the receipt of information indicating the player's choice to continue play of the multi-level game, entering the player in an additional round of the multi-level game;
randomly determining an additional set of winning entries for the additional round of the multi-level game;
determining whether the player entry is a winning entry in the additional round of the multilevel game based, at least in part, on a comparison of the player entry and the additional set of winning entries; and
conditioned on the player winning the additional round of the multi-level game, awarding the player a larger prize than the base prize.

10. The method of claim 9, further comprising:
conditioned on the player losing the additional round of the multi-level game; at least one of awarding the play no prize for that instance of the multi-level game or awarding the player a prize smaller than the base prize.

11. (canceled)

12. The method of claim 9, further comprising:
receiving an additional entry from the player, the additional entry being different than the base entry, the result of the additional round depending at least in part on a comparison between the additional entry and the and the additional set of winning entries.

13. The method of claim 12, wherein the player entry selection for the additional round is made after the player receives an indication that the initial entry is a winner.

14. The method of claim 9, wherein the player entry is a player-selected set of number-symbol pairs, and the winning entry is a randomly drawn set of number-symbol pairs.

15. The method of claim 9, further comprising:
displaying the winning entries to the player on a video display.

16. The method of claim 15, wherein the display includes at least one of a sport game theme, a racing game theme, a board game theme, or a casino game theme.

17. The method of claim 9, further comprising:
providing a set of preprinted game cards, each game card including a respective set of entry information;
receiving information indicating a player selection of one of the set of preprinted game cards, wherein the information indicating a player's entry is determined based on the information indicating a player selection one of the set of preprinted game cards, and the player's entry is based on the entry information on the player-selected game card.

18-20. (canceled)

21. The method of claim 9, wherein
the player's choice to continue play of the multi-level game is indicated by the failure of the player to redeem a winning ticket for the initial game round by a predetermined deadline.

22. A method for facilitating the play of a multi-level game of chance, comprising;
receiving information indicating a player's entry in a base round in the multi-level game of chance;
providing a receipt to the player, the receipt including a representation of the player's entry for the base round of the multi-level game;
randomly determining a set of winning entries for the base round of the multi-level game; and
determining whether the player's entry is a winning entry in the base round of the multi-level game based, at least in part, on a comparison of the player's entry and the winning entries;
conditioned on the player presenting their ticket for redemption of a base round prize and on the player's entry being a winning entry in the base round, awarding the base prize to the player and ending the player's participation in that instance of the multi-level game;
conditioned on the player winning the base round of the multi-level game, and the player failing to redeem their ticket prior to a predetermined deadline, automatically entering the player in an additional round of the multi-level game;
randomly determining an additional set of winning entries for the additional round of the multi-level game;
determining whether the player entry is a winning entry in the additional round of the multilevel game based on a comparison of the player entry and the additional set of winning entries; and
conditioned on the player winning the additional round of the multi-level game, awarding the player a larger prize than the base prize.

23. (canceled)

24. A system facilitating the play of a multi-level game of chance, comprising:
an input device configured to receive information indicating a player's entry in the multi-level game for a base round, the entry including at least one of a player-selected set of entry information or a quick pick entry;
an output device configured to provide a receipt including a representation of the player's entry for the base round of the multi-level game;
a random outcome generator configured to determine a winning draw for the base round of the multi-level game;
a processor in communication with the input device, the output device, and the random outcome generator,
the processor configured to determine whether the player entry is a winning entry in the base round of the multi-level game based, at least in part, on a comparison of the player entry for the base round and the winning draw for the base round,
the processor further configured to, conditioned on the player having a winning entry in the base round and responsive to the receipt of information indicating the player's choice to receive the base prize from the input device, to cause the base prize to be awarded the player and to end the player's participation in that instance of the multi-level game,
the processor further configured to, responsive to the receipt of information indicating the player's choice to continue play of the multi-level game for the additional round, to enter the player in the additional round of the multi-level game,
the processor further configured to, after the player is entered in the additional round of the multi-level game, to receive an additional winning draw for the additional round of the multi-level game from the random outcome generator and to determine whether the player entry is a winning entry in the additional round of the multilevel game based on a comparison of the player entry and the additional winning draw,
the processor further configured to, conditioned on the player winning the additional round of the multi-level game, to cause a prize of greater value than the base prize to be awarded to the player.

25. The system of claim 24, wherein the processor is further configured to, conditioned on the player winning the base round of the multi-level game, to cause an offer to be made to the player, the offer including a choice between receiving a base prize and continued play of the multi-level game for an additional round.

26. The system of claim 24, wherein the receipt includes one of a printed ticket, an electronic ticket, printed information added to a pre-printed player-selected play card, an email, a mobile telephone text message, or information stored on a smart card.

27. The system of claim 26, further comprising:
a plurality of pre-printed entry cards including entry information, wherein the input device is further configured to receive information identifying a player-selected one of the plurality of pre-printed entry cards, and wherein the processor is further configured to determine whether the player is a winner based, at least in part, on the entry information from the player-selected one of the plurality of pre-printed entry cards.

28. The system of claim 24, further comprising:
an electronic display in communication with the processor, the display configured to display the winning draw to the player.

29. The system of claim 24, wherein the input device includes at least one of an agent-operated lottery terminal, a player-operated kiosk, a mobile telephone, a PDA, a personal computer, or an Internet web server.

30-33. (canceled)
